(19) United States
(12) Patent Application Publication
(10) Pub. No.: US 2023/0063302 A1
(43) Pub. Date: Mar. 2, 2023

(54) DATA PROCESSING APPARATUS AND DATA PROCESSING METHOD

(71) Applicant: SONY GROUP CORPORATION, TOKYO (JP)

(72) Inventors: SUBARU KITAE, TOKYO (JP); YOSHIHIRO SHIMIZU, TOKYO (JP); KEISUKE ITO, TOKYO (JP); NATSUMI HAMAJIMA, TOKYO (JP)

(21) Appl. No.: 17/754,260

(22) PCT Filed: Sep. 28, 2020
(86) PCT No.: PCT/JP2020/036517

§ 371 Date: Oct. 24, 2022

(30) Foreign Application Priority Data
Oct. 9, 2019 (JP) 2019-185987

(51) Int. Cl. A63F 13/69; A63F 13/45; A63F 13/26; A63F 13/798

(52) U.S. Cl. CPC A63F 13/69; A63F 13/45; A63F 13/26; A63F 13/798; A63F 2300/8094

(57) ABSTRACT

The present technology relates to a data processing apparatus and a data processing method that are to enable a user to virtually experience cooking for making a dish while sharing with another user.

A data processing apparatus according to one aspect of the present technology includes: a generation unit configured to integrate virtual-cooking-process data indicating a process of virtual cooking in which a detail changes in response to a user operation on a cooking application for achievement of the virtual cooking as virtual cooking on an application, as integrated virtual-cooking-process data indicating the process of the virtual cooking by each of a plurality of users, for sharing between the plurality of users, the generation unit being configured to generate recipe data for a dish. The present technology is applicable to an application for smartphones.

### TECHNICAL FIELD

The present technology particularly relates to a data processing apparatus and a data processing method that enable a user to virtually experience cooking for making a dish while sharing with another user.

### BACKGROUND ART

Conventionally, there is a cooking game with which cooking is simulated and enjoyed. Patent Document 1 describes a technique for determining success or failure of a cooking game and presenting the achievement level to the user.

### CITATION LIST

### Patent Document

Patent Document 1: Japanese Patent Application Laid-Open No. 2009-28504

### SUMMARY OF THE INVENTION

### Problems to be Solved by the Invention

The technique described in Patent Document 1 allows the user to individually enjoy cooking experience as a game. Naturally, the user cannot eat the dish.

The present technology has been made in view of such a situation, and is to enable a user to virtually experience cooking for making a dish while sharing with another user.

### Solutions to Problems

A data processing apparatus according to one aspect of the present technology includes: a generation unit configured to integrate virtual-cooking-process data indicating a process of virtual cooking in which a detail changes in response to a user operation on a cooking application for achievement of the virtual cooking as virtual cooking on an application, as integrated virtual-cooking-process data indicating the process of the virtual cooking by each of a plurality of users, for sharing between the plurality of users, the generation unit being configured to generate recipe data for a dish.

A data processing apparatus according to another aspect of the present technology includes: a setting unit configured to set virtual-cooking-process data indicating a process of virtual cooking in which a detail changes in response to a user operation on a cooking application for achievement of the virtual cooking as virtual cooking on an application, such that the virtual-cooking-process data is shared between a plurality of users.

In one aspect of the present technology, virtual-cooking-process data indicating a process of virtual cooking in which a detail changes in response to a user operation on a cooking application for achievement of the virtual cooking as virtual cooking on an application is shared between a plurality of users. Further, the virtual-cooking-process data is integrated as integrated virtual-cooking-process data indicating the process of the virtual cooking by each of a plurality of users, and recipe data for a dish is generated.

In another aspect of the present technology, virtual-cooking-process data indicating a process of virtual cooking in which a detail changes in response to a user operation on a cooking application for achievement of the virtual cooking as virtual cooking on an application is set such that the virtual-cooking-process data is shared between a plurality of users.

### BRIEF DESCRIPTION OF DRAWINGS

FIG. 1 is a diagram illustrating an exemplary configuration of an information processing system according to an embodiment of the present technology.

FIG. 2 is a diagram illustrating a flow of overall processing in the information processing system.

FIG. 3 is a diagram illustrating a state where a virtual dish is reproduced.

FIG. 4 is a diagram illustrating a basic flow of virtual cooking.

FIG. 5 is a diagram illustrating an exemplary ingredient selection screen.

FIG. 6 is a diagram illustrating an operation for selecting ingredients to be used for the virtual cooking.

FIG. 7 is a diagram illustrating an exemplary display of the result of the selected ingredients.

FIG. 8 is a diagram illustrating an exemplary display of the result of the selected ingredients.

FIG. 9 is a diagram illustrating an exemplary display of other ingredients.

FIG. 10 is a diagram illustrating exemplary purchase of an ingredient.

FIG. 11 is a diagram illustrating an exemplary cooking screen.

FIG. 12 is a diagram illustrating an exemplary cooking screen in cutting of an ingredient.

FIG. 13 is a diagram illustrating an exemplary cooking screen in cutting of the ingredient.

FIG. 14 is a diagram illustrating an exemplary cooking screen in pouring of a seasoning.

FIG. 15 is a diagram illustrating another exemplary cooking screen in frying of the ingredient.

FIG. 16 is a diagram illustrating exemplary virtual-cooking-process data.

FIG. 17 is a diagram illustrating exemplary integration of virtual-cooking-process data.

FIG. 18 is a diagram illustrating exemplary cooperation in virtual cooking processes.

FIG. 19 is a diagram illustrating an exemplary screen at the cooperation in the virtual cooking processes.

FIG. 20 is a diagram illustrating exemplary cooperation in virtual cooking processes.

FIG. 21 is a diagram illustrating exemplary redoing of virtual cooking.

FIG. 22 is a diagram illustrating other exemplary redoing of virtual cooking.

FIG. 23 is a diagram illustrating exemplary description details of recipe data.

FIG. 24 is a diagram illustrating exemplary reproduction of a dish.

FIG. 25 is a diagram illustrating an exemplary achievement of a virtual cooking process.

FIG. 26 is a diagram illustrating another exemplary achievement of a virtual cooking process.

FIG. 27 is a diagram illustrating an exemplary configuration of a control system.

FIG. 28 is a diagram illustrating an exemplary disposition of a data processing apparatus.

FIG. 29 is a diagram illustrating exemplary conversion of recipe data.

FIG. 30 is a diagram illustrating a state where a dish reproduced by a cooking apparatus is delivered.

FIG. 31 is a block diagram illustrating an exemplary hardware configuration of a portable-kitchen management server.

FIG. 32 is a block diagram illustrating an exemplary functional configuration of the portable-kitchen management server.

FIG. 33 is a block diagram illustrating an exemplary configuration of a mobile terminal.

FIG. 34 is a block diagram illustrating an exemplary functional configuration of the mobile terminal.

FIG. 35 is a flowchart illustrating processing of the portable-kitchen management server.

FIG. 36 is a flowchart illustrating processing of a cooking application of the mobile terminal.

FIG. 37 is a timing chart of virtual cooking.

FIG. 38 is a diagram illustrating an exemplary display screen for a highlighted moving image.

FIG. 39 is a diagram illustrating exemplary ranking according to a skill level.

### MODE FOR CARRYING OUT THE INVENTION

<Overview of Present Technology>

The present technology allows a plurality of users to share cooking processes up to completion of a dish. Cooking until the completion of the dish is performed as virtual cooking by the plurality of users in cooperation, on an application installed in a mobile terminal held by each of the plurality of users, for example.

Further, the present technology reproduces the dish completed by the virtual cooking as a real dish in real space.

Each user can share and experience the cooking until the completion of the dish as virtual cooking with another user, and can actually eat the same dish as that completed by such virtual cooking.

Note that a dish means a product obtained through cooking. Cooking means a process of making a dish or an action (work) of making a dish.

Hereinafter, modes for carrying out the present technology will be described. The description will be given in the following order.

1. Portable Kitchen System

2. Virtual Cooking

3. Reproduction of Dish

4. Configuration of Each Apparatus

5. Operation of Each Apparatus

6. Specific example of Virtual Cooking

7. Other Examples

<Portable Kitchen System>

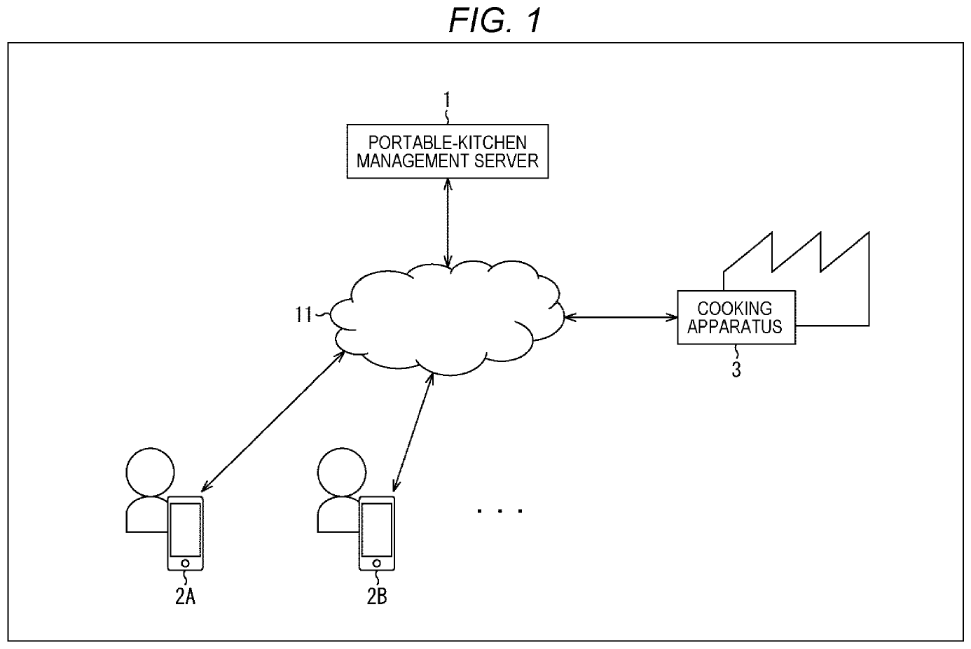

FIG. 1 is a diagram illustrating an exemplary configuration of an information processing system according to an embodiment of the present technology.

The information processing system of FIG. 1 includes a portable-kitchen management server 1, mobile terminals 2A and 2B, and a cooking apparatus 3 in mutual connection through a network 11 such as the Internet.

The portable-kitchen management server 1 communicates with the mobile terminals 2A and 2B as terminals such as smartphones. Further, the portable-kitchen management server 1 communicates with the cooking apparatus 3 provided in a factory or the like, and transmits information regarding the details of cooking to the cooking apparatus 3. The portable-kitchen management server 1 may be provided near the cooking apparatus 3 or may be provided at a different place.

Although FIG. 1 illustrates the two mobile terminals of the mobile terminal 2A and the mobile terminal 2B, a number of mobile terminals, of which the number is identical to the number of users using the information processing system, are provided in the information processing system of FIG. 1. Hereinafter, when it is not necessary to distinguish each mobile terminal, the mobile terminals are collectively referred to as a mobile terminal 2 as appropriate.

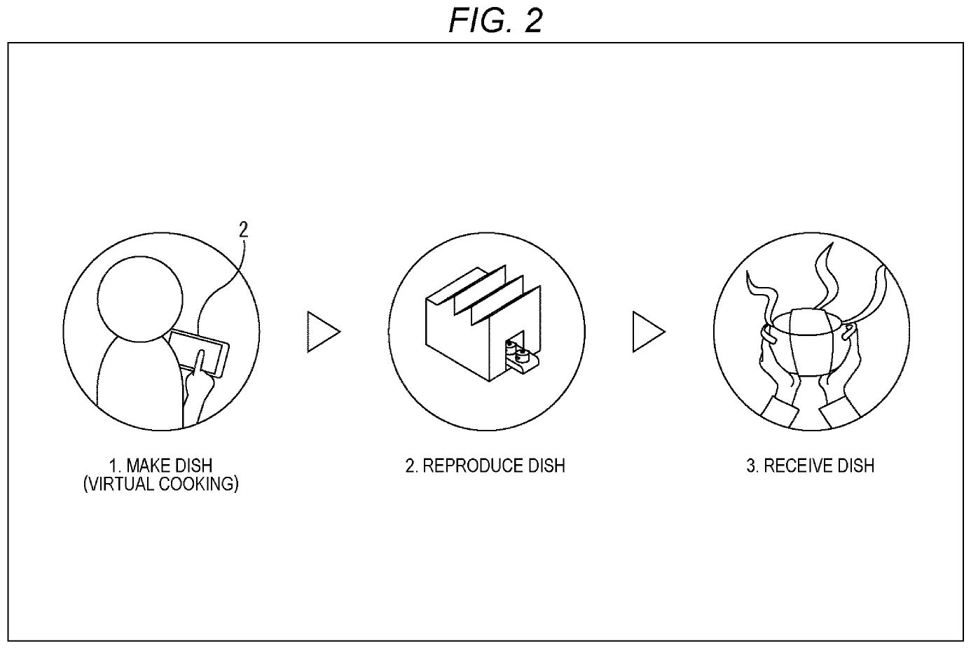

FIG. 2 is a diagram illustrating a flow of overall processing in the information processing system.

As illustrated on the left of FIG. 2, the user of the mobile terminal 2 performs cooking on an application by operating the mobile terminal 2 and makes a dish. Because the cooking is performed on the application, the cooking by operating the mobile terminal 2 is virtual cooking, that is, virtual cooking (virtual cooking).

In the mobile terminal 2 as a smartphone, a cooking application as an application for achievement of such virtual cooking is installed.

The virtual cooking performed on the cooking application includes operations such as selection of a dish, selection of an ingredient to be used for cooking, selection of a cooking tool, and selection of a specific cooking method. Various cooking methods performed in real cooking, such as cutting, frying, mixing an ingredient, and pouring a seasoning, can also be selected in virtual cooking.

Such virtual cooking is performed in cooperation by a plurality of users such as friends. For example, virtual cooking is performed in cooperation between the user A who is the user of the mobile terminal 2A and the user B who is the user of the mobile terminal 2B. In the virtual cooking, the two persons perform cooking in a single process or the two persons share processes such that the user A is in charge of a certain process and the user B is in charge of the next process.

In the portable-kitchen management server 1, virtual-cooking-process data indicating the details of virtual cooking by each user is generated and managed in association with the user. In a case where the virtual cooking is finished and the dish is completed, in the portable-kitchen management server 1, recipe data is generated on the basis of the cooking process data for each user.

Generally, a single dish is completed through a plurality of cooking processes. The recipe data includes information indicating the details of the virtual cooking having been performed by a user in each cooking process.

As illustrated in the center of FIG. 2, with the cooking apparatus 3 provided in the factory, a virtual dish made by the virtual cooking is reproduced as a real dish in real space on the basis of the recipe data. Because a real dish is reproduced, cooking with the cooking apparatus 3 is performed by physical reaction, with a real ingredient, a real cooking tool, and a real seasoning, to the ingredient.

The reproduction of the dish proceeds using the same ingredient as that having been used in the virtual cooking, the same cooking tool as that having been used in the virtual cooking, and the same seasoning as that having been used in the virtual cooking.

Further, the reproduction of the dish proceeds using the same cooking method as that selected by a user in the virtual cooking. The respective manners of cutting, frying, mixing, and pouring a seasoning are reproduced, for example.

The cooking apparatus 3 has a configuration for reproducing, as a physical operation, such cooking having been performed by the user as virtual cooking. The recipe data includes information for controlling the operation of each configuration provided in the cooking apparatus 3.

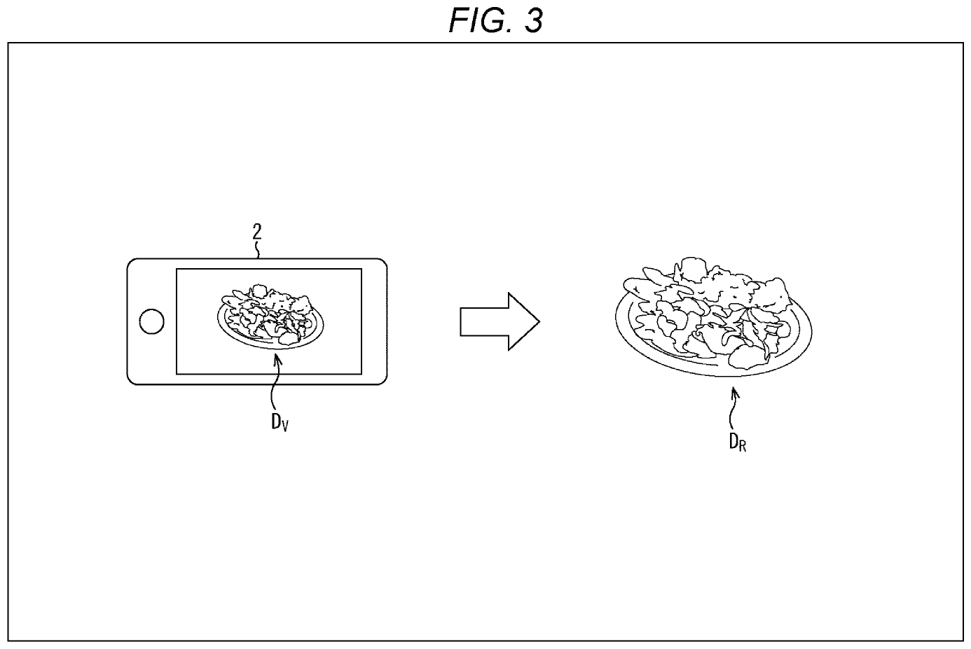

In a case where the same cooking as all the cooking having been performed by a user as virtual cooking is performed by the cooking apparatus 3, a virtual dish made by the virtual cooking is reproduced as a real dish in real space as illustrated in FIG. 3. In the example of FIG. 3, a virtual dish Dv made by virtual cooking is reproduced as a real dish DR.

The dish reproduced by the cooking apparatus 3 is delivered from the factory to a store such as a convenience store and received by the user of the mobile terminal 2 as illustrated on the right of FIG. 2.

As described above, the information processing system of FIG. 1 reproduces a virtual dish completed by virtual cooking having been performed by the user of the mobile terminal 2, as a real dish in real space.

Each user can virtually experience the cooking, and can actually eat the same dish as that completed by the virtual cooking.

Here, listed are the following points important for cooking.

1. The sense of the main character who performs creation with his/her hands

2. Collaboration with others

3. Sharing of processes up to completion of a dish

When these three points are achieved, it is considered that a person who has performed cooking can enjoy a sense of fulfillment for the cooking.

For example, in a case where a dish is automatically made by a robot or the like, the sense of the main character in the point 1 cannot be obtained. Further, in a case where cooking is performed by a single person, the collaboration in the point 2 and the sharing of processes in the point 3 are lacked, and thus the person who has performed the cooking feels the cooking as a mere work.

The information processing system of FIG. 1 is to enable obtainment of a sense of fulfillment for cooking, due to cooking while sharing the processes, in collaboration with other users such as friends, by creation of a dish with the user's hands.

Because cooking can be performed at a desired time and at a desired place, even the user who cannot allocate a large time to cooking can perform cooking enabling obtainment of such a sense of fulfillment by utilizing a vacant time at, for example, a place outside the home.

As described above, the information processing system of FIG. 1 can also be referred to as a portable kitchen system that provides a kitchen serving as a portable cooking place.

In the example of FIG. 1, a smartphone is used as the mobile terminal 2. However, as the mobile terminal 2, used may be a different information processing apparatus, such as a tablet terminal, a personal computer (PC) or the like, on which various applications can be installed.

Further, although virtual cooking is performed on the cooking application, the virtual cooking may be performed on a Website provided by the portable-kitchen management server 1. In this case, the user of the mobile terminal 2 performs virtual cooking using a Web browser as an application installed in the mobile terminal 2.

Furthermore, although the cooking apparatus 3 is provided in the factory, the cooking apparatus 3 may be provided in the home of the user. In this case, the user of the mobile terminal 2 can perform virtual cooking at a place outside the home and can receive, at home, a dish reproduced by the cooking apparatus 3.

Processing of each apparatus for achievement of the above processing will be described later with reference to flowcharts.

<Virtual Cooking>

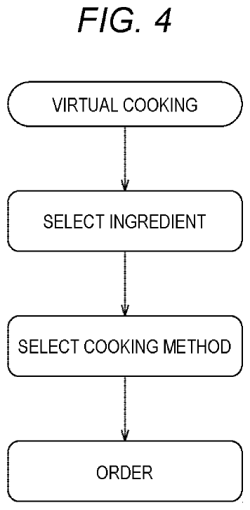

FIG. 4 is a diagram illustrating a basic flow of virtual cooking.

As illustrated in FIG. 4, the virtual cooking includes three processes of selection of an ingredient, selection of a cooking method, and order. A screen corresponding to each process is displayed on a display of the mobile terminal 2 by the cooking application on the basis of information transmitted from the portable-kitchen management server 1.

Before selecting an ingredient, the user of the mobile terminal 2 considers what dish to make. In a case where a plurality of persons makes a dish in cooperation, what dish is to be made may be determined by exchange of messages on the screen of the cooking application.

Hereinafter, a case where the user A of the mobile terminal 2A and the user B of the mobile terminal 2B perform virtual cooking in cooperation will be described mainly. The details of the operation having been performed with each of the mobile terminal 2A and the mobile terminal 2B are managed in the portable-kitchen management server 1. On the basis of information transmitted from the portable-kitchen management server 1 to the mobile terminal 2A and the mobile terminal 2B, the details of the operation of the user A and the details of the operation of the user B are synchronized together. The details of the operation by one user is reflected in real time on the display of the mobile terminal 2 operated by the other user.

After the determination of what to make, the user of the mobile terminal 2 then selects an ingredient in accordance with the dish.

(1) Selection of Ingredients

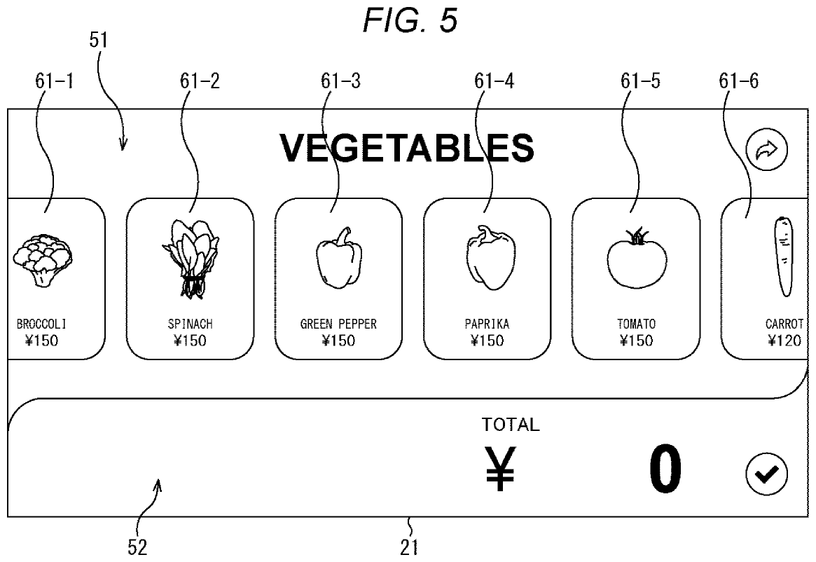

FIG. 5 is a diagram illustrating an exemplary ingredient selection screen displayed on a display 21 of the mobile terminal 2.

The ingredient selection screen is a purchase screen for an ingredient to be used in virtual cooking. The ingredient selection screen includes an ingredient display area 51 provided in the upper part of the screen and a selection-result display area 52 provided in the lower part thereof.

In the ingredient display area 51, respective images of ingredients as selection candidates are displayed side by side. In the example of FIG. 5, the category of vegetables is selected, and respective images 61-1 to 61-6 as vegetable images are displayed. An ingredient name and the amount of money are displayed in each image.

In response to a lateral slide operation in the ingredient display area 51, respective images of other vegetables are displayed instead of the images 61-1 to 61-6. The ingredients are each managed by being divided into categories such as vegetables, meat, fish, and fruits. Selection of a category enables making a switch to an ingredient to be displayed.

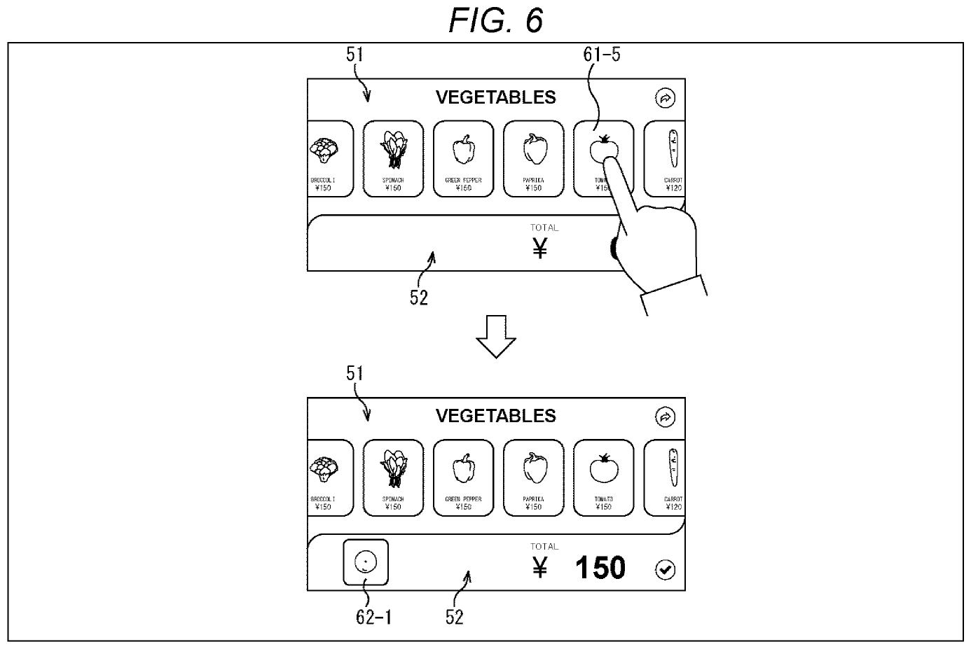

On such an ingredient selection screen, the user can select an ingredient to be used for virtual cooking by tapping a finger on the image of the ingredient as illustrated in the upper part of FIG. 6.

In the example of FIG. 6, tomato displayed as the image 61-5 is selected as the selected ingredient. In response to the selection of the tomato, an image 62-1 of the tomato is displayed in the selection-result display area 52 as illustrated in the lower part of FIG. 6. On the right of the selection-result display area 52, it is displayed that the amount of money for the tomato selected by the user is 150 yen.

The user continues such an ingredient selection while appropriately making a switch between the categories.

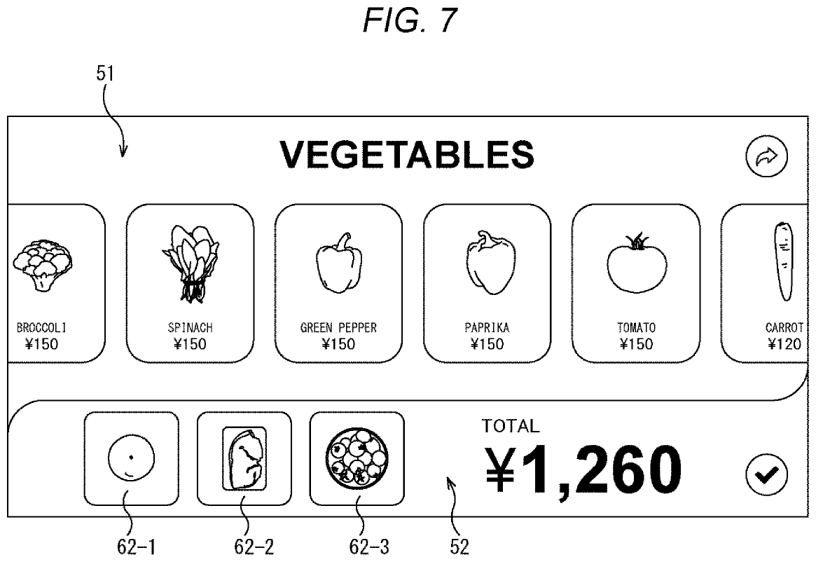

FIG. 7 is a diagram illustrating another exemplary ingredient selection screen.

In response to selection of steak meat and cherry tomato following the tomato, an image 62-2 representing the selected steak meat and an image 62-3 representing the cherry tomato are displayed in the result display area 52 as illustrated in FIG. 7. In the example of FIG. 7, the total amount of money for the tomato, the steak meat, and the cherry tomato is displayed as 1260 yen.

The user can also determine what dish to make by looking at ingredients.

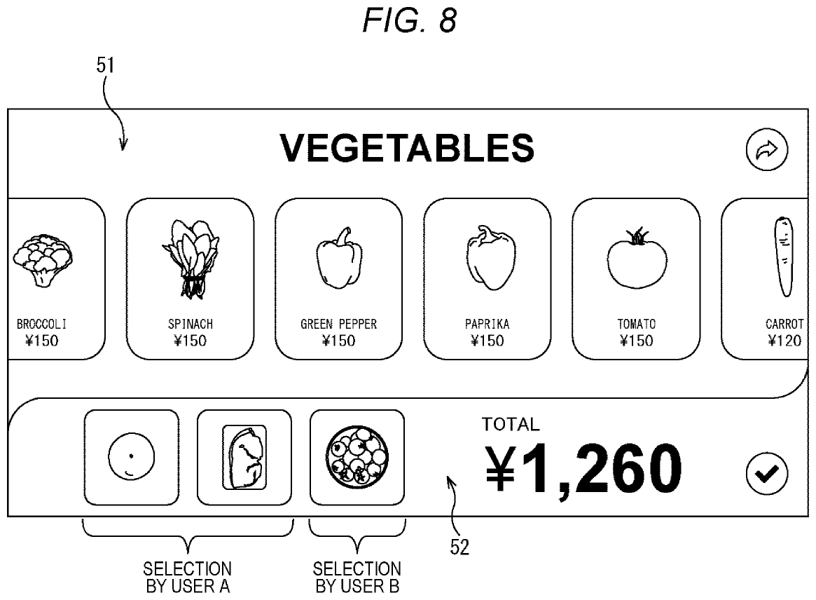

Selection of the ingredients can also be performed by a plurality of users in cooperation. In the example of FIG. 8, the user A has selected the tomato and the steak meat, and the user B has selected the cherry tomato.

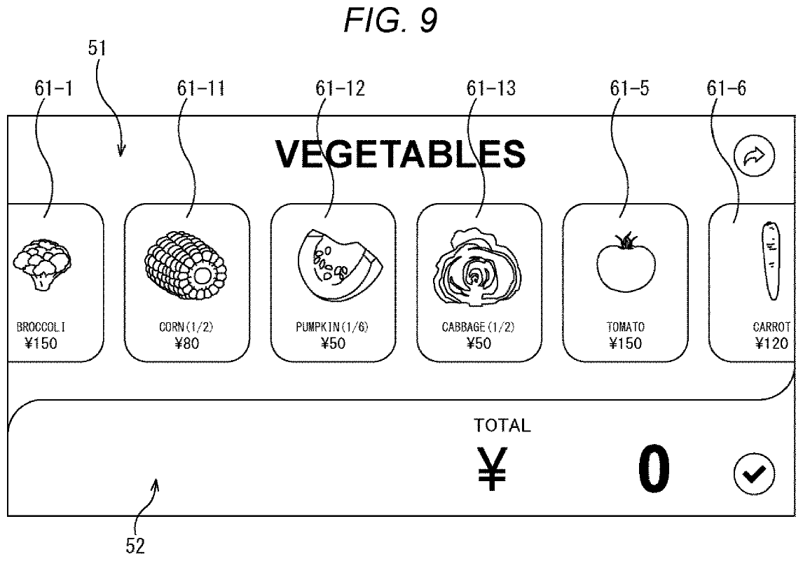

FIG. 9 is a diagram illustrating an exemplary display of other ingredients.

The ingredient displayed as an image 61-11 on the ingredient selection screen of FIG. 9 is a ½ size of corn. The ingredient displayed as an image 61-12 is a ⅙ size of pumpkin, and the ingredient displayed as an image 61-13 is a ½ size of cabbage. The amount of money for each ingredient is the discount amount of money.

The ingredients displayed as the images 61-11 to 61-13 are the remainders of ingredients having been used in virtual cooking by another user.

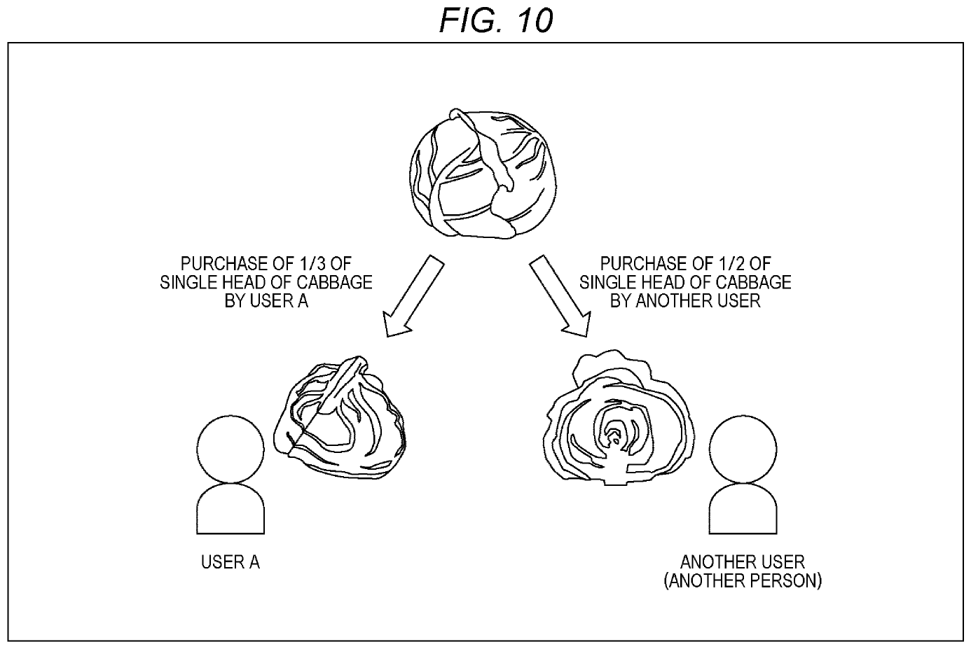

FIG. 10 is a diagram illustrating exemplary purchase of an ingredient.

In the example of FIG. 10, a ½ of a single head of cabbage is purchased by another user (a user other than the user A and the user B), and a ⅓ of the single head of cabbage is purchased by the user A. As described above, on the ingredient selection screen, for example, selected can be an ingredient a user wants to use by the amount the user wants to use, as an ingredient to be used in virtual cooking.

Further, the user can also purchase the remainder of an ingredient. In this case, the image of an ingredient prepared (remaining) in the factory is displayed on the ingredient selection screen, for example.

This display allows selection by the amount the user wants to use, so that the user can purchase the ingredient at a lower price. Further, food loss can be reduced.

After the selection of the ingredients to be used in the virtual cooking as described above and the determination of purchasing the ingredients, the processing in the process of the virtual cooking proceeds to selection of a cooking method.

(2) Selection of Cooking Method

After the selection of the ingredients to be cooked, a cooking screen to be used for selecting a specific cooking method is displayed on the display of the mobile terminal 2. An ingredient to be cooked is selected from the purchased ingredients.

Exemplary Cooking Screen

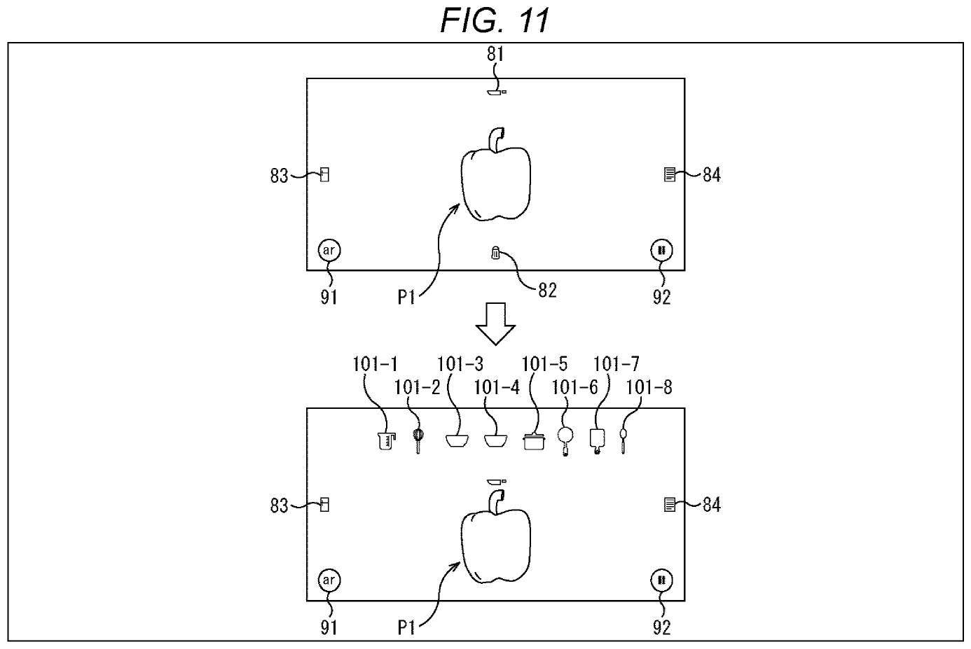

FIG. 11 is a diagram illustrating an exemplary cooking screen.

The cooking screen illustrated in the upper part of FIG. 11 is a screen displayed in response to selection of paprika as an ingredient to be cooked. An image P1 of the paprika as an ingredient to be cooked is displayed at the center of the screen. An operation on the screen enables the orientation of the image P1 to be changed.

In the example of FIG. 11, although the single ingredient is displayed as an ingredient to be cooked, a plurality of ingredients may be displayed simultaneously. Not only a plurality of ingredients of the same type but also a plurality of ingredients different in type can also be displayed on the cooking screen.

A cooking tool icon 81, a seasoning icon 82, an ingredient icon 83, and a recipe icon 84 are displayed at the respective centers of upper, lower, left, and right edges of the cooking screen. A comment button 91 and a pause button 92 are displayed at the lower left and lower right of the cooking screen, respectively.

The cooking tool icon 81 is an icon tapped to select a cooking tool.

The seasoning icon 82 is an icon tapped to select a seasoning.

The ingredient icon 83 is an icon tapped to select an ingredient to be cooked. In response to tapping on the ingredient icon 83, the purchased ingredients are displayed and an ingredient to be cooked can be selected.

The recipe icon 84 is an icon tapped to retrieve a recipe.

The comment button 91 is a button tapped to display a comment regarding virtual cooking. The comment function for the virtual cooking will be described later.

The pause button 92 is a button tapped to cause the virtual cooking to pause. The user can interrupt the virtual cooking at any timing by pressing the pause button 92. Releasing the pause allows the user to resume the virtual cooking from the state before the pause.

In response to tapping on the cooking tool icon 81 in a state where such a cooking screen as illustrated in the upper part of FIG. 11 is displayed, icons 101-1 to 101-8 each representing a cooking tool are displayed side by side along the upper edge of the screen as illustrated in the lower part of FIG. 11.

For example, the leftmost icon 101-1 is an icon representing a measuring cup as a cooking tool. The measuring cup is used to measure an ingredient.

In addition, the icon 101-2 is an icon representing a whisk as a cooking tool. The whisk is used to mix an ingredient.

Similarly, the icon 101-6 is an icon representing a frying pan as a cooking tool. The frying pan is used to fry an ingredient.

In response to a lateral slide operation in the vicinity of the arrangement of the icons 101-1 to 101-8, respective icons representing other cooking tools are displayed instead of the icons 101-1 to 101-8. The cooking tools displayed in response to the tapping on the cooking tool icon 81 also includes a kitchen knife as a cooking tool.

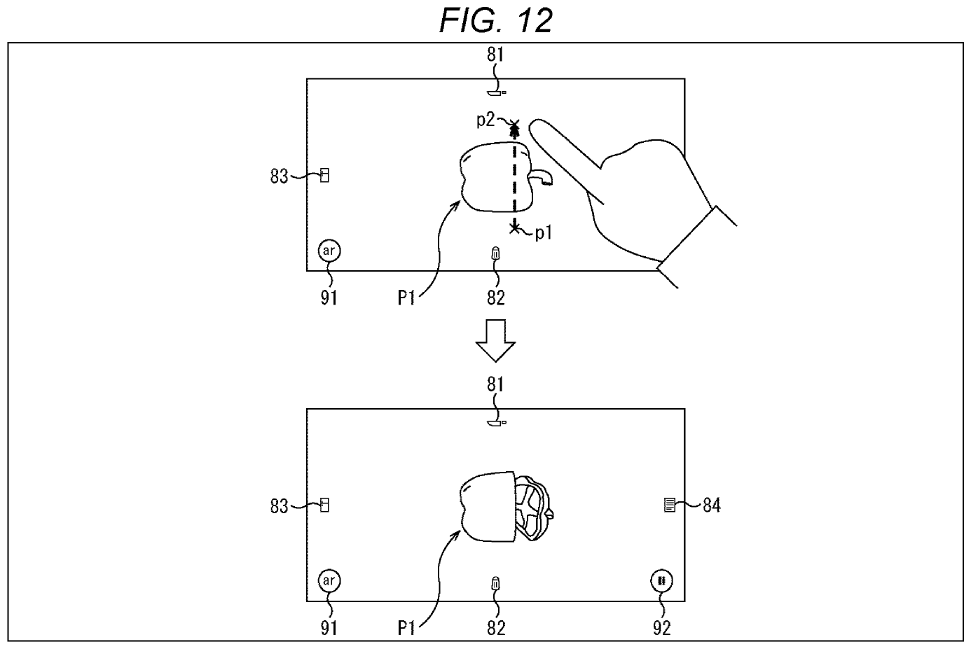

FIG. 12 is a diagram illustrating an exemplary cooking screen in cutting of an ingredient.

In a case where the user selects a kitchen knife as a cooking tool with the image P1 of the paprika turned sideways and performs an operation of sliding the kitchen knife from a position p1 to a position p2 on the screen such that the kitchen knife passes a position slightly on the right from the center of the image P1 as indicated by a broken line arrow in the upper part of FIG. 12, the image P1 changes to an image of the paprika cut at the passed position as illustrated in the lower part of FIG. 12.

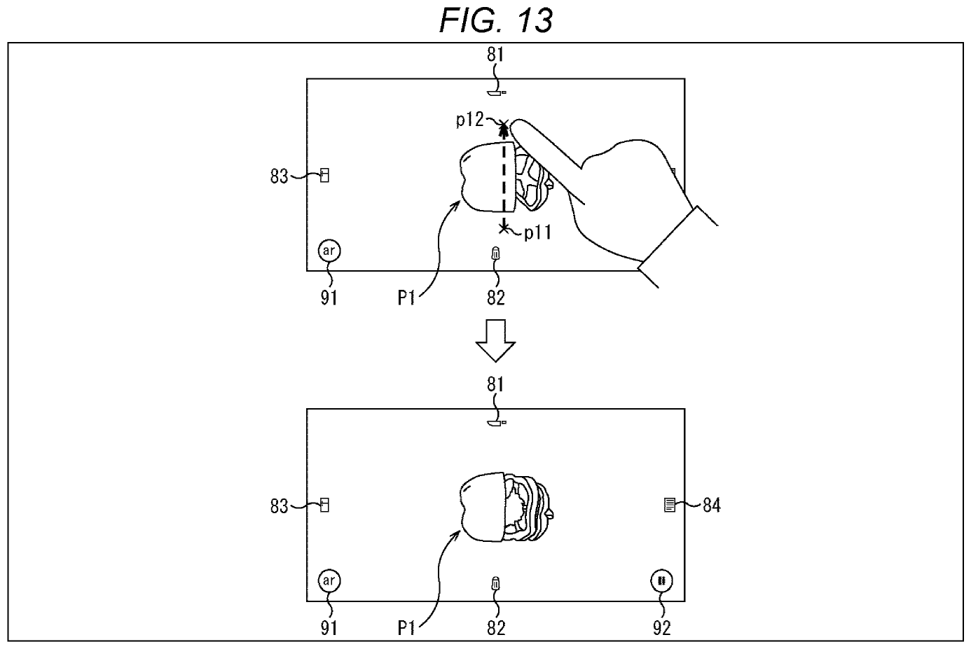

Following the first cut, in a case where the user performs an operation of sliding the kitchen knife from a position p11 to a position p12 on the screen such that the kitchen knife passes substantially the center of the image P1 as indicated by a broken line arrow in the upper part of FIG. 13, the image P1 changes to an image of the paprika cut at substantially the center as illustrated in the lower part of FIG. 13.

The user can cut the paprika by appropriately changing the orientation of the image P1 and repeating a slide operation for passing over the image P1.

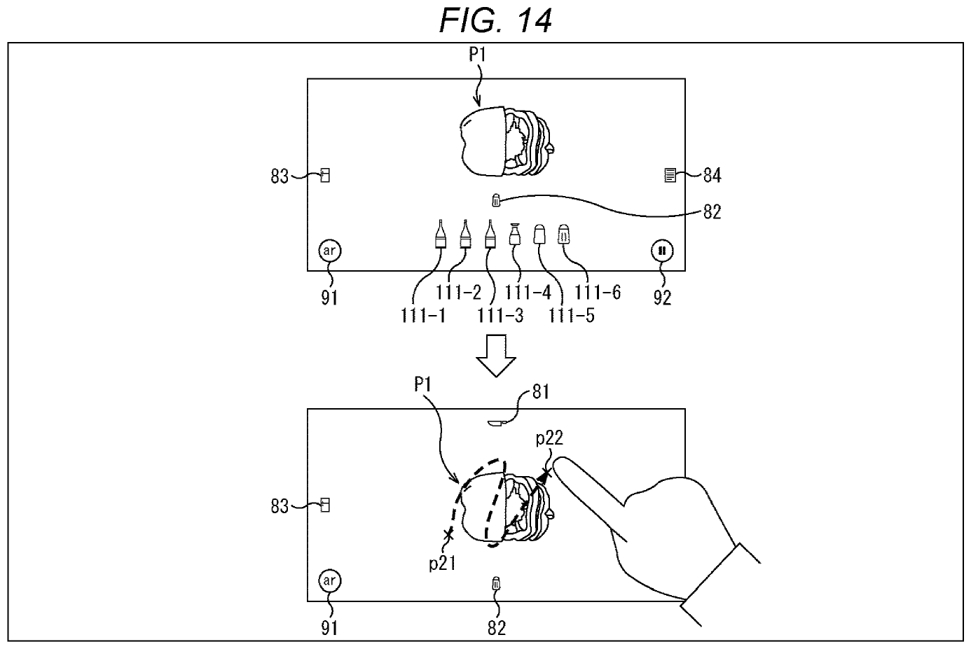

FIG. 14 is a diagram illustrating an exemplary cooking screen in pouring of a seasoning.

The cooking screen illustrated in the upper part of FIG. 14 is a screen displayed in response to tapping on the seasoning icon 82 after the completion of cutting the paprika. In response to the tapping on the seasoning icon 82, as illustrated in the upper part of FIG. 14, icons 111-1 to 111-6 each representing a seasoning are displayed side by side along the lower edge of the screen.

For example, the leftmost icon 111-1 is an icon representing cooking sake as a seasoning. Further, the icon 111-4 is an icon representing soy sauce as a seasoning. Similarly, the icon 111-5 is an icon representing salt as a seasoning.

In response to a lateral slide operation in the vicinity of the arrangement of the icons 111-1 to 111-6, respective icons representing other seasonings are displayed instead of the icons 111-1 to 111-6.

The user selects the icon of a seasoning and performs an operation of sliding the seasoning from a position p21 to a position p22 on the screen as indicated by a broken line arrow in the lower part of FIG. 14, whereby an operation of pouring the seasoning onto the paprika is performed.

While the operation of pouring the seasoning is performed, for example, information indicating the amount of the seasoning poured is displayed on the right of the image P1.

In such a manner, the user can use a desired seasoning by the amount the user wants to use from various seasonings prepared in the factory.

For a real dish, generally, even if there is a seasoning to be tried, it is highly likely that the seasoning cannot be used up. Thus, the user may hesitate to purchase the seasoning. The user, however, can try the seasoning that the user wants to try, without hesitation. Further, food loss can be reduced.

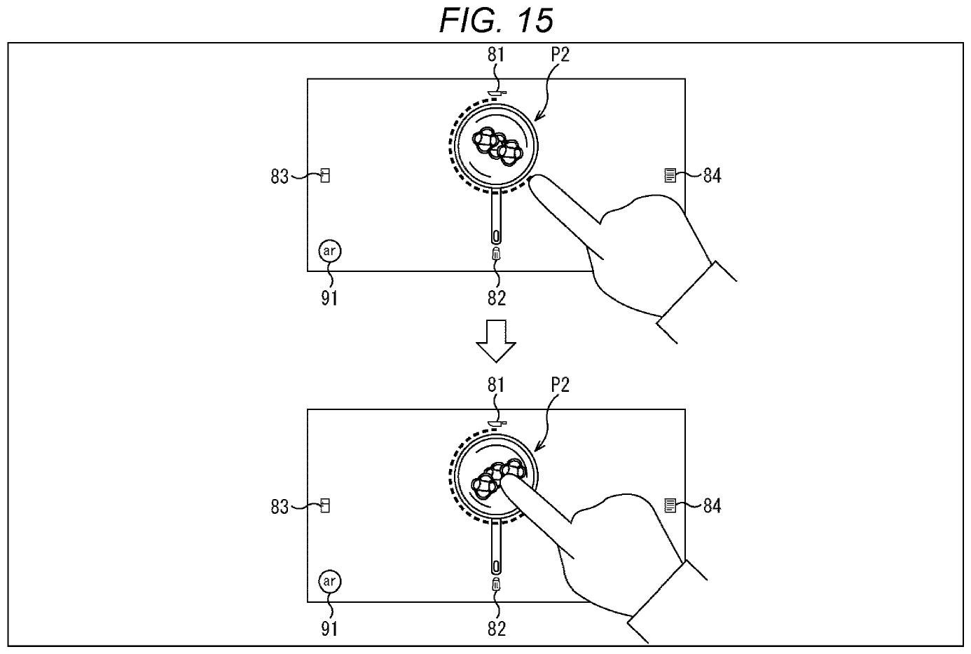

FIG. 15 is a diagram illustrating an exemplary cooking screen in frying of the ingredient.

The cooking screen illustrated in FIG. 15 is a screen displayed in response to selection of the frying pan as a cooking tool. In a case where it is selected to fry, with the frying pan, the paprika with the seasoning poured thereon, an image P2 of the frying pan on which the paprika is placed is displayed at substantially the center of the cooking screen as illustrated in the upper part of FIG. 15.

The user can adjust the level of heating (amount of heat) with an indicator displayed by a broken line around the image P2. Further, as illustrated in the lower part of FIG. 15, the user moves the image of the paprika with a finger, thereby passing heat through the whole.

The selection of a cooking method using the cooking screen is advanced by changing an ingredient to be cooked, a cooking tool, and a seasoning as described above. The operation using the cooking screen is continued until cooking of all the ingredients is completed.

Note that selection of an ingredient to be cooked is performed so as to select not only an ingredient having not yet been cooked but also a cooked ingredient having already been subjected to other cooking such as cutting.

Virtual-Cooking-Process Data

Information indicating the details of virtual cooking performed in response to such a user operation is transmitted, by the cooking application, to the portable-kitchen management server 1 every time cooking is performed. In the portable-kitchen management server 1, the details of the virtual cooking by the user is managed with the virtual-cooking-process data.

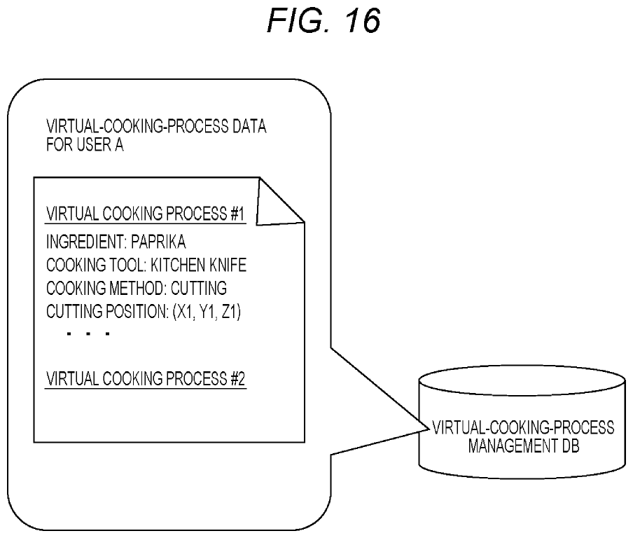

FIG. 16 is a diagram illustrating exemplary virtual-cooking-process data.

As illustrated in FIG. 16, a virtual-cooking-process management database (DB) as a DB for virtual-cooking-process data is provided in the portable-kitchen management server 1. In the virtual-cooking-process data, information indicating an ingredient to be cooked, a cooking tool, the category of cooking methods, and the details of a specific cooking method is described for each virtual cooking process.

A single virtual cooking process includes, for example, a process of virtual cooking in response to a series of user operations having been performed on the same ingredient. In information regarding the single virtual cooking process, at least the ingredient and the cooking tool are associated with each other. In the example of FIG. 16, information regarding a virtual cooking process #1 and a virtual cooking process #2 is described in the virtual-cooking-process data for the user A.

In a case where the category of cooking methods is “cutting”, information such as the orientation of the ingredient, the position where the ingredient has been cut, and the number of times of cutting is recorded as information indicating the details of the specific cooking method. In a case where paprika to be cooked is cut as described above, the virtual-cooking-process data describes that the ingredient is the paprika, the cooking tool is a kitchen knife, and others, as illustrated in FIG. 16.

Further, in a case where the category of cooking methods is “frying”, information such as the level of heating, the frying time, and the orientation of the ingredient is recorded as information indicating the details of the specific cooking method.

In the portable-kitchen management server 1, such virtual-cooking-process data is generated and managed for each user. The virtual-cooking-process data is updated every time each user performs cooking. Further, in the portable-kitchen management server 1, virtual-cooking-process data for a plurality of users performing virtual cooking in cooperation is integrated.

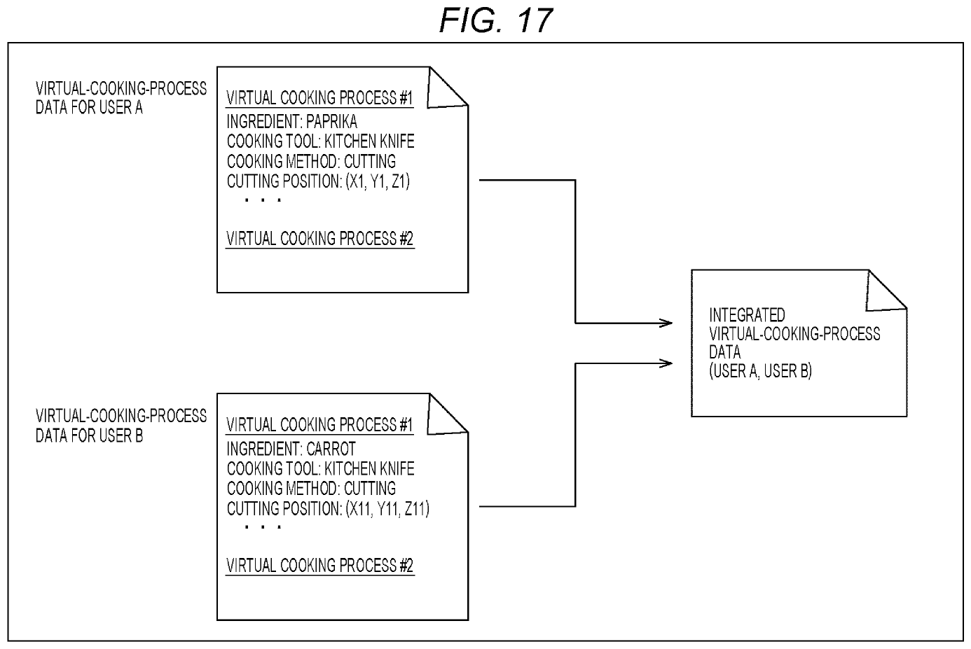

FIG. 17 is a diagram illustrating exemplary integration of virtual-cooking-process data.

In the example of FIG. 17, virtual-cooking-process data for the user A and virtual-cooking-process data for the user B are integrated as a single piece of integrated virtual-cooking-process data. The integrated virtual-cooking-process data includes information regarding the virtual cooking process for the user A and information regarding the virtual cooking process for the user B.

The details of the integrated virtual-cooking-process data is updated each time at least either the virtual-cooking-process data for the user A or the virtual-cooking-process data for the user B is updated. The virtual-cooking-process data for each user is transmitted to the mobile terminal 2A and the mobile terminal 2B on the basis of the integrated virtual-cooking-process data, so that secured is synchronization of the virtual cooking processes between the cooking application of the mobile terminal 2A and the cooking application of the mobile terminal 2B.

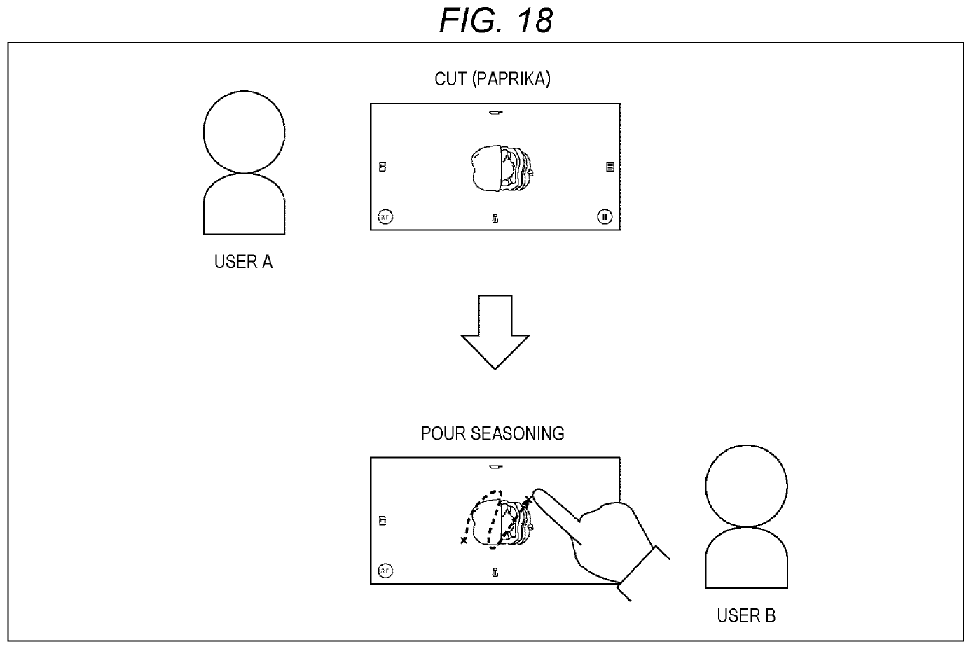

The synchronization of each virtual cooking process enables cooperation such as the user A cutting an ingredient and the user B pouring seasoning onto the ingredient cut by the user A as illustrated in FIG. 18.

Cooperation in Virtual Cooking Processes

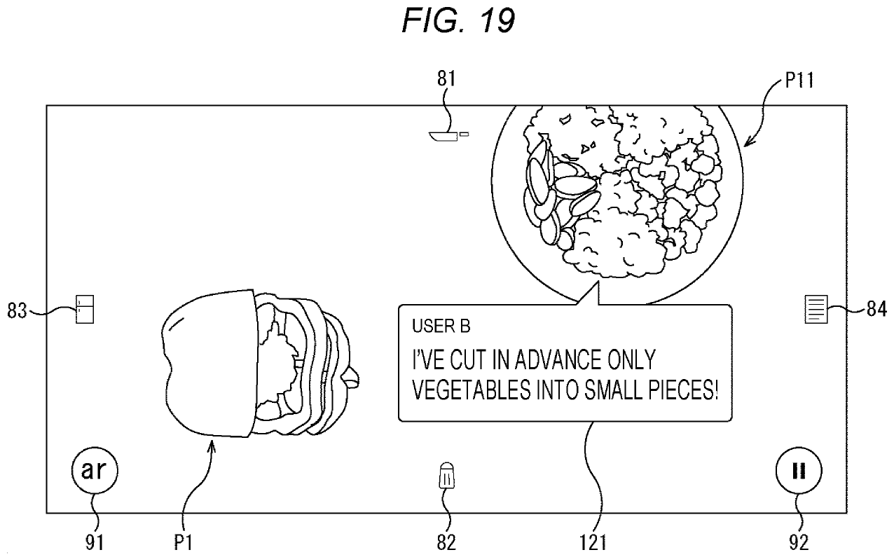

FIG. 19 is a diagram illustrating an exemplary screen at the cooperation in virtual cooking processes.

The cooking screen illustrated in FIG. 19 is, for example, a screen displayed on the mobile terminal 2A used by the user A. In a case where the user B has finished cutting another ingredient while the user A is cutting the paprika, an image P11 representing the cut ingredient is displayed together with a message from the user B.

In the example of FIG. 19, the message input by the user B through the mobile terminal 2B is displayed in a balloon 121. The message input by the user B is transmitted to the mobile terminal 2A through the portable-kitchen management server 1, for example.

As described above, in the virtual cooking, the user A can take over the virtual cooking process for the user B and can proceed with cooking of the ingredient having been cooked by the user B. On the other hand, the user B can take over the virtual cooking process for the user A and can proceed with cooking of the ingredient having been cooked by the user A.

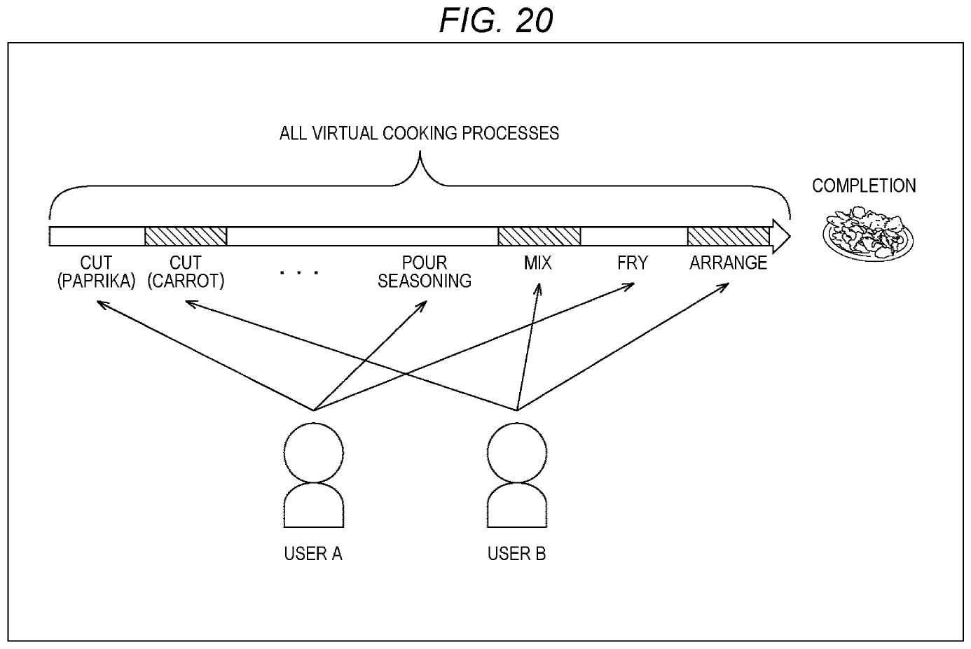

FIG. 20 is a diagram illustrating exemplary cooperation in virtual cooking processes.

Because the virtual cooking processes can be cooperated, the virtual cooking processes up to the completion of the dish can be shared by the user A and the user B as illustrated in FIG. 20. The user A and the user B can make the dish in cooperation even in a case where the user A and the user B are at distant places.

In the example of FIG. 20, the user A is in charge of three virtual cooking processes of cutting the paprika, pouring the seasoning onto the cut ingredients, and frying among all the virtual cooking processes until the completion of the dish. In addition, the user B is in charge of three virtual cooking processes of cutting the carrot, mixing, and arranging.

Sharing on a single virtual cooking process basis, the user A and the user B can perform the virtual cooking little by little by, for example, using a free time. In accordance with selection of a recipe (what dish to make), sharing of the virtual cooking processes up to the completion of the dish may be determined automatically.

Information indicating the workload of the virtual cooking may be displayed on the respective screens of the mobile terminal 2A and the mobile terminal 2B in conjunction with the respective user operations by the user A and the user B. The information indicating the workload is displayed on the basis of, for example, the virtual-cooking-process data in synchronization.

The display of the information indicating the workload of each user enables each user to further enhance the sense of teamwork.

Because cooking on the cooking application is virtual cooking, a user can perform an operation in the same virtual cooking process a plurality of times. For example, if the user does not like the virtual cooking once performed, the user can redo the same virtual cooking.

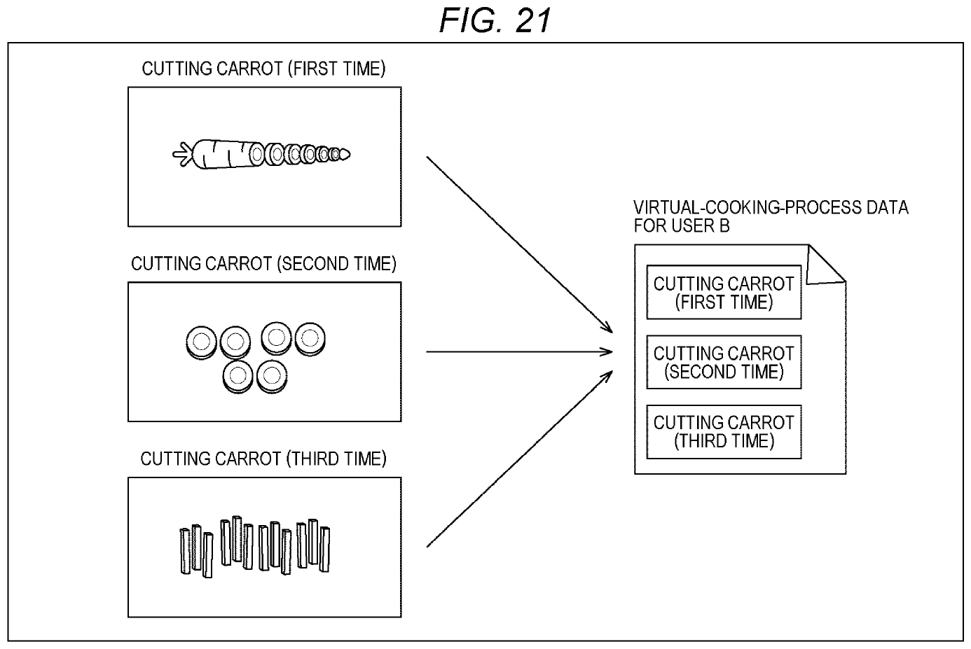

FIG. 21 is a diagram illustrating exemplary redoing of the virtual cooking.

As illustrated in FIG. 21, in a case where the user B has cut the carrot three times, information indicating the details of each cut is described in the virtual-cooking-process data for the user B. A history regarding the virtual cooking having the process constant is described in the virtual-cooking-process data.

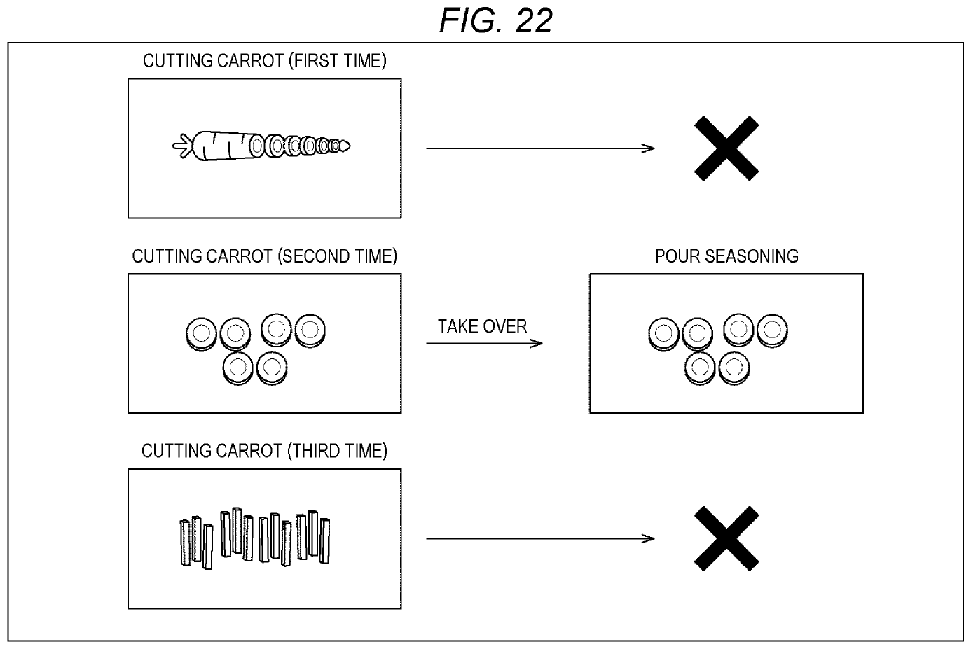

In this case, the user A who takes over the virtual cooking process of cutting the carrot by the user B and pours the seasoning onto the cut carrot can select which cut to take over as illustrated in FIG. 22. In the example of FIG. 22, the second cutting is taken over, and the virtual cooking of pouring the seasoning is performed with the cut carrot obtained in the second cutting.

As a result, a user can perform virtual cooking in another virtual cooking process following the virtual cooking having been performed successfully.

Similarly, in a case where consecutive virtual cooking processes are performed by a single person, the user can proceed with the next virtual cooking process following the virtual cooking process having been performed successfully among the virtual cooking processes that the user has performed a plurality of times.

Comment Function Using Augmented Reality (AR) Function

In response to tapping on the comment button 91 provided on the cooking screen, an operation to be as a sample of virtual cooking is presented to the user using, for example, an AR function. For example, in response to tapping on the comment button 91 while the user is cutting an ingredient, a moving image showing the state of cutting the ingredient is displayed on the display 21 so as to be superimposed on an image of the surrounding scenery captured by a camera of the mobile terminal 2.

In a case where the virtual dish is completed after the selection of the cooking method using the cooking screen is completed, the processing in the process of the virtual cooking proceeds to an order. The order is an order regarding reproduction of the dish made by the virtual cooking as a real dish.

(3) Order

In response to a predetermined operation on the screen of the cooking application after the completion of the virtual dish by the virtual cooking, an order screen is displayed on the display 21 of the mobile terminal 2.

On the order screen, selection of the number of orders, payment for the fee, selection of a pickup destination, selection of pickup date and time, and others are performed. The fee to be paid by the user includes the fee for the ingredients selected on the ingredient selection screen, the fee for reproduction of the dish, the delivery fee, and others.

The fee for the seasonings having been used on the cooking screen, the usage fee for the cooking tools, and others may be included. The fee for the seasonings varies depending on, for example, the type of seasonings or the amount having been used. The usage fee for the cooking tools also varies depending on the type of cooking tools, the usage time, and others.

After the various selections are performed, order information is transmitted from the cooking application to the portable-kitchen management server 1. The order information includes information indicating the details of the selections by the user.

In response to the order, the portable-kitchen management server 1 generates recipe data on the basis of the integrated virtual-cooking-process data. The recipe data is data describing a time series of virtual cooking processes up to the completion of a single dish, in combination of information regarding the virtual cooking process of the virtual cooking by each user described in the integrated virtual-cooking-process data.

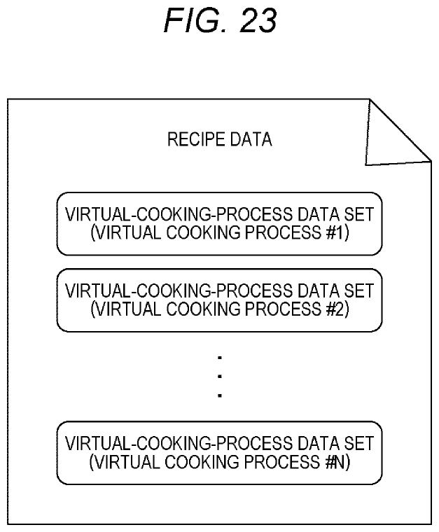

FIG. 23 is a diagram illustrating exemplary description details of the recipe data.

As illustrated in FIG. 23, the recipe data includes a plurality of virtual-cooking-process data sets. In the example of FIG. 23, a virtual-cooking-process data set as information regarding a virtual cooking process #1, a virtual-cooking-process data set as information regarding a virtual cooking process #2, . . . , and a virtual-cooking-process data set as information regarding a virtual cooking process #N are included in the recipe data.

The virtual cooking processes #1 to #N are the virtual cooking processes for the user A or the user B. In the case of the above example, the recipe data includes a virtual-cooking-process data set regarding the respective virtual cooking processes of cutting the paprika, cutting the carrot, pouring the seasoning onto the cut ingredients, mixing, frying, and arranging.

Each virtual-cooking-process data set includes ingredient information, cooking tool information, and operation information. The ingredient information and the cooking tool information selected in each virtual cooking process of the virtual cooking are associated with each other.

The ingredient information is information regarding an ingredient having been used in a virtual cooking process. The ingredient information includes, for example, identification information of the ingredient. As described above, such ingredients include not only an ingredient that is not subjected to virtual cooking at all but also a cooked (pre-treated) ingredient obtained by being subjected to certain virtual cooking. The ingredient information regarding a certain virtual cooking process includes information regarding an ingredient having undergone a virtual cooking process prior to the certain virtual cooking process.

The cooking tool information is information regarding a cooking tool having been used in a virtual cooking process. The cooking tool information includes identification information of the cooking tool.

The operation information is information regarding a user operation having been performed on the cooking screen.

For example, operation information regarding the virtual cooking process of cutting an ingredient includes information indicating the orientation of the ingredient, the position of cutting, the number of times of cutting, the angle, the speed, and others.

In addition, operation information regarding the virtual cooking process of pouring a seasoning onto the ingredient includes information indicating the type of seasoning, the amount of seasoning, the time for pouring the seasoning, the speed, and others.

Operation information regarding the virtual cooking process of frying the ingredient includes information indicating the level of heating, the time for frying, and how to mix the ingredient on the cooking tool.

Operation information regarding the virtual cooking process of arranging includes information regarding the manner of arranging indicating tableware to be used for arranging, how to dispose the ingredient, the color of the ingredient, and others.

A dish is reproduced on the basis of the recipe data including such pieces of information.

<Reproduction of Dish>

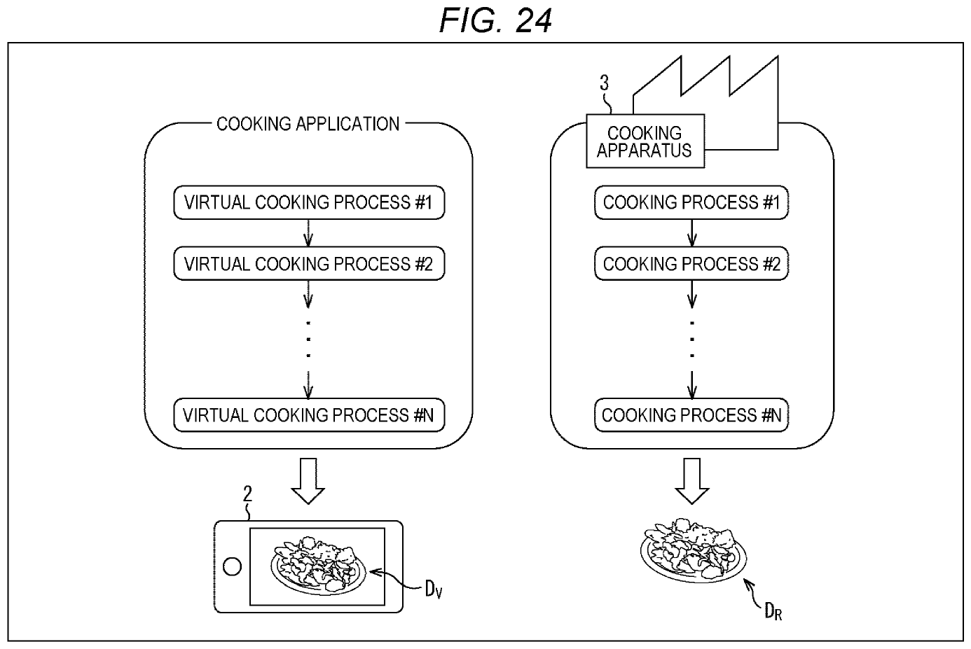

FIG. 24 is a diagram illustrating exemplary reproduction of a dish.

As illustrated in FIG. 24, the cooking apparatus 3 achieves the same cooking processes as the virtual cooking processes #1 to #N having been performed in the virtual cooking on the cooking application as real cooking processes. The achievement of the cooking processes #1 to #N as the real cooking processes by the cooking apparatus 3 results in reproduction of a virtual dish Dv as a real dish DR as illustrated in the lower part of FIG. 24.

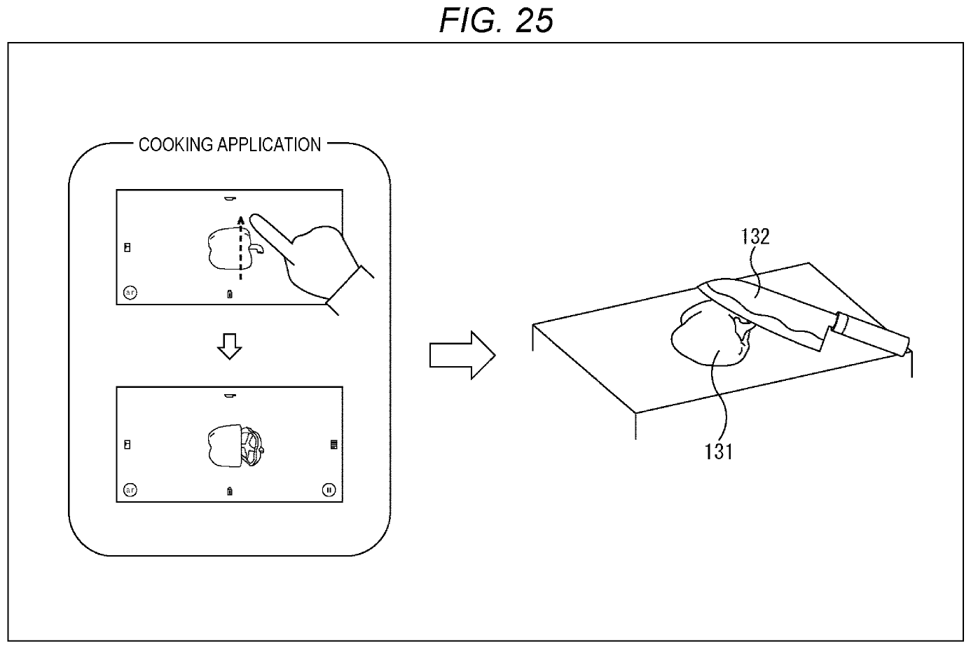

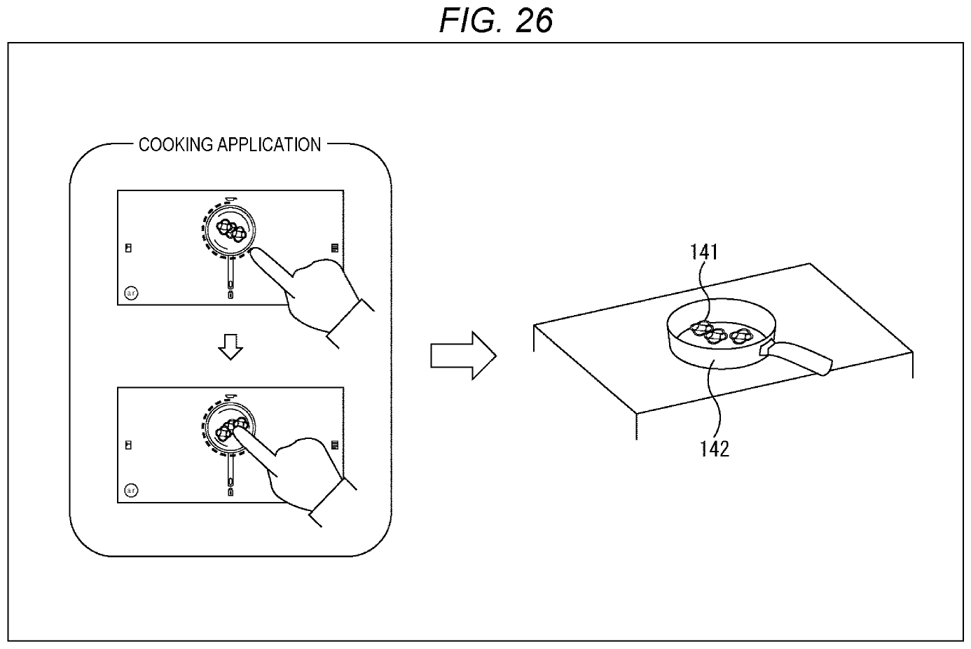

FIGS. 25 and 26 each illustrate an exemplary achievement of a virtual cooking process.

In a case where cooking of cutting paprika at a predetermined position is performed as virtual cooking as illustrated on the left of FIG. 25, cooking of cutting prepared paprika 131 with a kitchen knife 132 is achieved by the cooking apparatus 3 as illustrated on the right of FIG. 25. The cutting position is controlled to be the same position as the cutting position in the virtual cooking.

In addition, in a case where cooking of frying the paprika is performed as virtual cooking as illustrated on the left of FIG. 26, cooking of frying cut paprika 141 in a frying pan 142 is achieved by the cooking apparatus 3 as illustrated on the right of FIG. 26. The level of heating and the frying time for frying the paprika 141 are controlled to be the same level of heating and the same time as those selected in the virtual cooking.

The virtual cooking processes of virtual cooking are achieved one by one as a real cooking process, a real dish is reproduced finally.

The cooking apparatus 3 is a cooking robot having a function of actually performing such cooking. For example, the cooking apparatus 3 is provided with a cooking arm capable of holding and moving various cooking tools such as a kitchen knife.

Further, the cooking apparatus 3 is provided with a heat source such as a cooking stove. The cooking apparatus 3 can fry an ingredient by holding, with the cooking arm, a frying pan with the ingredient placed therein and moving the frying pan onto the cooking stove.

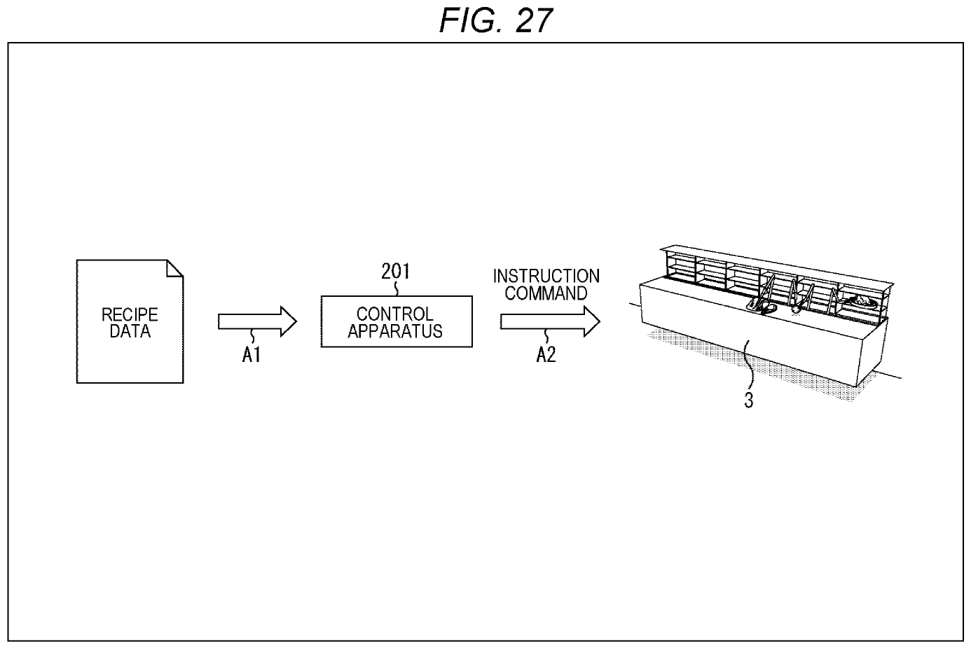

FIG. 27 is a diagram illustrating an exemplary configuration of a control system.

As illustrated in FIG. 27, the control system includes a control apparatus 201 and the cooking apparatus 3. The cooking apparatus 3 is a robot having a drive-system device such as the cooking arm and various sensors and having a function of cooking installed in the cooking apparatus 3.

The control apparatus 201 is an apparatus that controls the cooking apparatus 3. The control apparatus 201 includes a computer or the like.

For example, in response to input of recipe data as indicated by an arrow A1, the control apparatus 201 outputs an instruction command on the basis of the description of the recipe data as indicated by an arrow A2, and controls the cooking operation of the cooking apparatus 3.

The cooking apparatus 3 drives each part such as the cooking arm according to the instruction command supplied from the control apparatus 201, and performs the cooking operation for each cooking process. The instruction command includes information or the like for controlling the torque, the direction of driving, and the amount of driving of a motor that the cooking arm is provided with.

Until the dish is completed, such instruction commands are sequentially output from control apparatus 201 to cooking apparatus 3. The cooking apparatus 3 performs each adjustment operation in response to the instruction command, whereby the dish is completed finally.

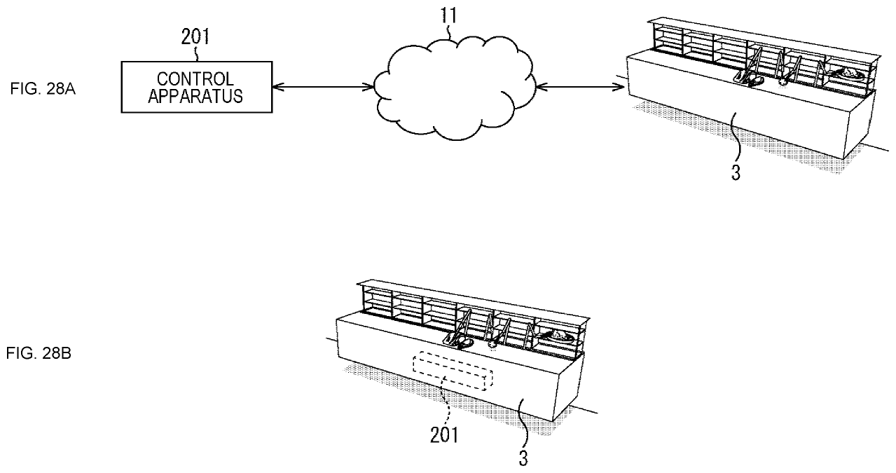

FIG. 28 is a diagram illustrating an exemplary disposition of the control apparatus 201.

As illustrated in A of FIG. 28, the control apparatus 201 is provided as, for example, an apparatus outside the cooking apparatus 3. In the example of A of FIG. 28, the control apparatus 201 and the cooking apparatus 3 are connected through the network 11. The function of the control apparatus 201 can also be achieved by the portable-kitchen management server 1.

Each instruction command transmitted from the control apparatus 201 is received by the cooking apparatus 3 through the network 11. Various types of data such as an image captured by a camera of the cooking apparatus 3 and sensor data measured by a sensor that the cooking apparatus 3 is provided with are transmitted from the cooking apparatus 3 to the control apparatus 201 through the network 11.

As illustrated in B of FIG. 28, the control apparatus 201 may be provided inside the housing of the cooking apparatus 3. In this case, according to an instruction command generated by the control apparatus 201, the operation of each part of the cooking apparatus 3 is controlled.

Hereinafter, a case where the portable-kitchen management server 1 has the function of the control apparatus 201 will be described mainly. The portable-kitchen management server 1 outputs an instruction command to the cooking apparatus 3.

Although the reproduction of the dish in the factory is performed by the cooking apparatus 3, the reproduction may be performed by a person. In this case, a plurality of persons (cooks) who cooks for each cooking process for reproducing the dish is disposed. Such a cook is a person different from the user of the mobile terminal 2.

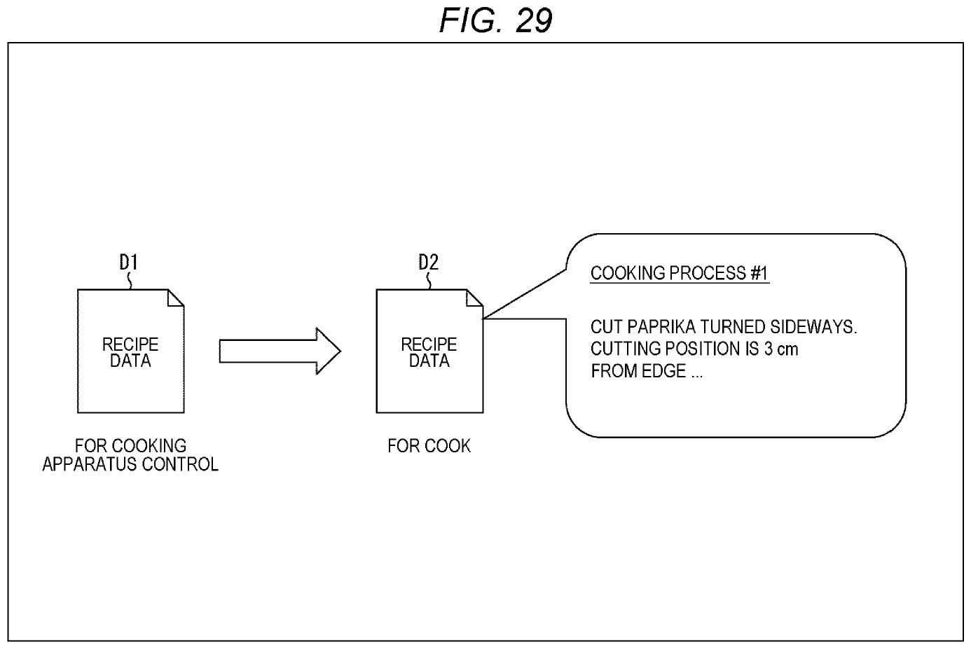

FIG. 29 is a diagram illustrating exemplary conversion of recipe data.

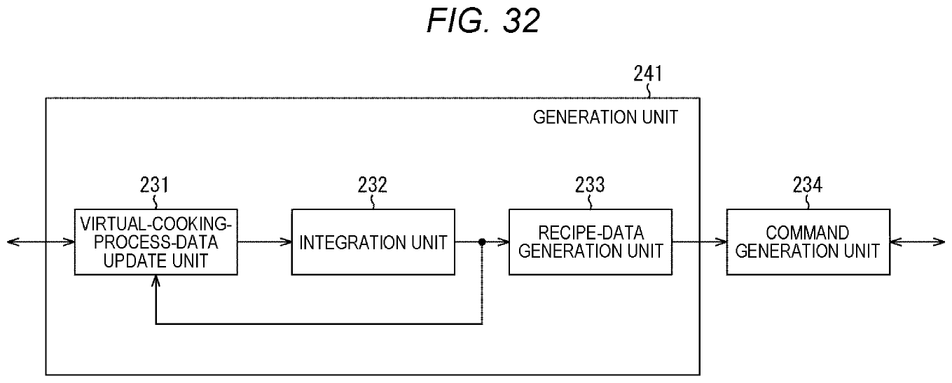

The recipe data generated by the portable-kitchen management server 1 is data in which information for controlling the cooking apparatus 3 is described. In the portable-kitchen management server 1, recipe data D1 for the cooking apparatus 3 is converted into recipe data D2 in which information readable by the cooks is described. For example, a conversion unit that converts recipe data generated by a recipe-data generation unit 233 is provided in a generation unit 241 (FIG. 32).

In the example of FIG. 29, information regarding explanatory text such as an ingredient to be cooked, a cooking tool to be used, and the position of cutting is described in the recipe data D2 as information regarding a certain cooking process.

On the basis of the recipe data D2, the cook performs cooking by the same method as that selected by the user in the virtual cooking and reproduces the dish. In the virtual cooking, the respective manners of cutting, frying, mixing, and pouring a seasoning selected by the user are reproduced by the cook, for example.

Instead of a person in the factory, a person registered as a cook for the portable kitchen system may perform cooking and may reproduce the dish at home, on the basis of the recipe data D2 transmitted from the portable-kitchen management server 1.

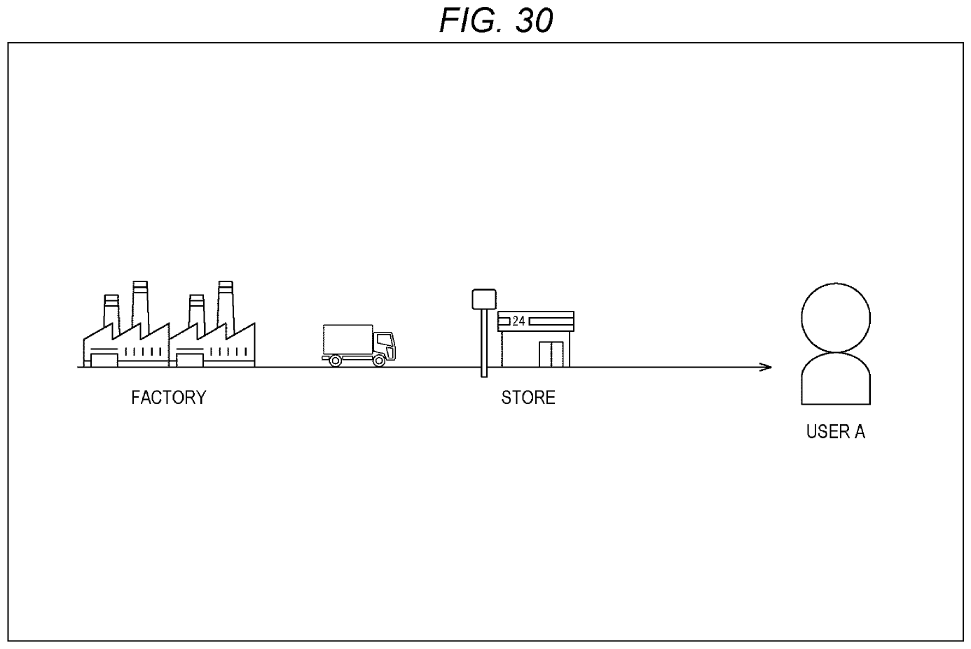

The dish reproduced by, for example, the cooking apparatus 3 as described above is delivered from the factory to the store designated by the user as illustrated in FIG. 30. In response to the delivery of the dish to the store, the cooking application issues a notification that the dish has been delivered. The user having confirmed the notification goes to the store and receives the dish.

In such a manner, the user can perform cooking at a desired place and at a desired time to complete the dish.

Furthermore, the user creates the dish with his/her hands, collaborates with other users, and progresses the dish while sharing the processes, thereby obtaining a sense of fulfillment for cooking.

<Configuration of Each Apparatus>

Here, a configuration of each apparatus for achievement of the information processing system will be described.

Configuration of Portable-Kitchen Management Server 1

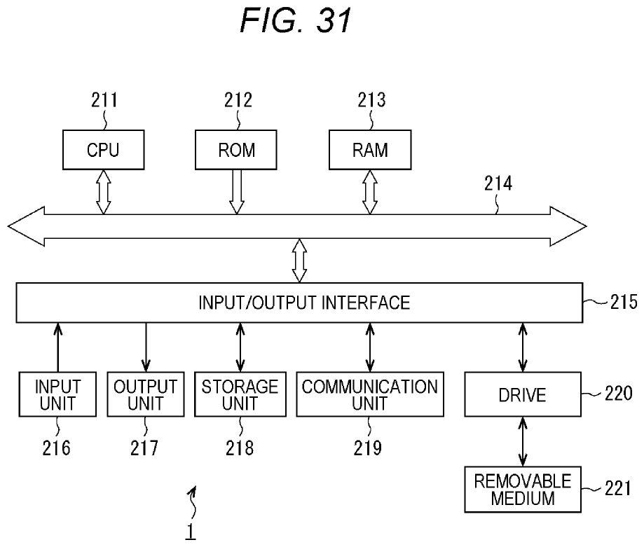

FIG. 31 is a block diagram illustrating an exemplary hardware configuration of the portable-kitchen management server 1.

As illustrated in FIG. 31, the portable-kitchen management server 1 includes a computer. The portable-kitchen management server 1 may include a plurality of computers. In a case where the portable-kitchen management server 1 includes a plurality of computers, the above virtual cooking is achieved by cooperation of each of the plurality of computers.

A central processing unit (CPU) 211, a read only memory (ROM) 212, and a random access memory (RAM) 213 are mutually connected through a bus 214.

Further, an input/output interface 215 is connected to the bus 214. An input unit 216, an output unit 217, a storage unit 218, a communication unit 219, and a drive 220 are connected to the input/output interface 215.

The input unit 216 includes a keyboard, a mouse, and the like. The output unit 217 includes a display or the like.

The storage unit 218 includes a hard disk, a non-volatile memory, and the like. The storage unit 218 stores various types of information such as a program executed by the CPU 211.

The communication unit 219 is an interface to the network 11. The communication unit 219 communicates with the mobile terminal 2 and the cooking apparatus 3. For example, the communication unit 219 receives information regarding a user operation transmitted from the mobile terminal 2. Further, the communication unit 219 transmits, to the mobile terminal 2, various types of information such as information to be used for screen display by the cooking application.

The drive 220 controls writing of data onto a removable medium 221 and reading of data from the removable medium 221.

In the computer having the configuration as above, for example, the CPU 211 loads a program stored in the storage unit 218 into the RAM 213 and executes the program, thereby providing virtual cooking.

FIG. 32 is a block diagram illustrating an exemplary functional configuration of the portable-kitchen management server 1.

As illustrated in FIG. 32, in the portable-kitchen management server 1, a virtual-cooking-process-data update unit 231, an integration unit 232, the recipe-data generation unit 233, and a command generation unit 234 are achieved.

The virtual-cooking-process-data update unit 231 has a virtual-cooking-process management DB described with reference to FIG. 16. The virtual-cooking-process-data update unit 231 communicates with the mobile terminal 2 and describes, in virtual-cooking-process data, the details of the virtual cooking process that changes in response to a user operation, thereby managing the virtual cooking performed by each user. Information indicating the details of the user operation performed by each user as the virtual cooking is transmitted from the mobile terminal 2 of the corresponding user.

The progress in the virtual cooking process described in the virtual-cooking-process data managed by the virtual-cooking-process-data update unit 231 changes for each user in response to the corresponding user operation. The virtual-cooking-process-data update unit 231 updates and manages the virtual-cooking-process data every time a user operation relating to the virtual cooking is performed. The virtual-cooking-process-data update unit 231 outputs the virtual-cooking-process data for each user to the integration unit 232.

In addition, on the basis of the integrated virtual-cooking-process data integrated by the integration unit 232, the virtual-cooking-process-data update unit 231 synchronizes the respective virtual cooking processes for the users who are making a dish in cooperation. For example, the virtual-cooking-process-data update unit 231 controls the communication unit 219 and transmits the virtual-cooking-process data for each user to the corresponding mobile terminal 2, thereby synchronizing the virtual cooking processes.

The integration unit 232 integrates the virtual-cooking-process data for each user who is making a dish in cooperation, among the virtual-cooking-process data managed by the virtual-cooking-process-data update unit 231 and manages the result as the integrated virtual-cooking-process data. The virtual-cooking-process data is integrated, for example, by replacing the order of the respective virtual cooking processes of the users represented by the virtual-cooking-process data or by merging the virtual cooking processes into a single virtual cooking process. The integrated virtual-cooking-process data managed by the integration unit 232 is supplied to the virtual-cooking-process-data update unit 231 and the recipe-data generation unit 233.

On the basis of the integrated virtual-cooking-process data for the users having finished the virtual cooking, the recipe-data generation unit 233 generates the recipe data described with reference to FIG. 23. The recipe data generated by the recipe-data generation unit 233 is supplied to the command generation unit 234.

The virtual-cooking-process-data update unit 231, the integration unit 232, and the recipe-data generation unit 233 achieve the generation unit 241 that generates, due to integration of a plurality pieces of virtual-cooking-process data, integrated virtual-cooking-process data indicating the virtual cooking process for each of the plurality of users, for sharing between the plurality of users, and further generates recipe data on the basis of the integrated virtual-cooking-process data. The portable-kitchen management server 1 functions as a data processing apparatus having the generation unit 241.

The command generation unit 234 communicates with the cooking apparatus 3 and outputs an instruction command on the basis of the description of the recipe data, thereby controlling the cooking operation of the cooking apparatus 3. The command generation unit 234 monitors the state of the cooking apparatus 3 on the basis of data transmitted from the cooking apparatus 3, and sequentially outputs instruction commands for performing respective cooking process. Such an instruction command output from the command generation unit 234 is transmitted from communication unit 219 to the cooking apparatus 3.

Configuration of Mobile Terminal 2

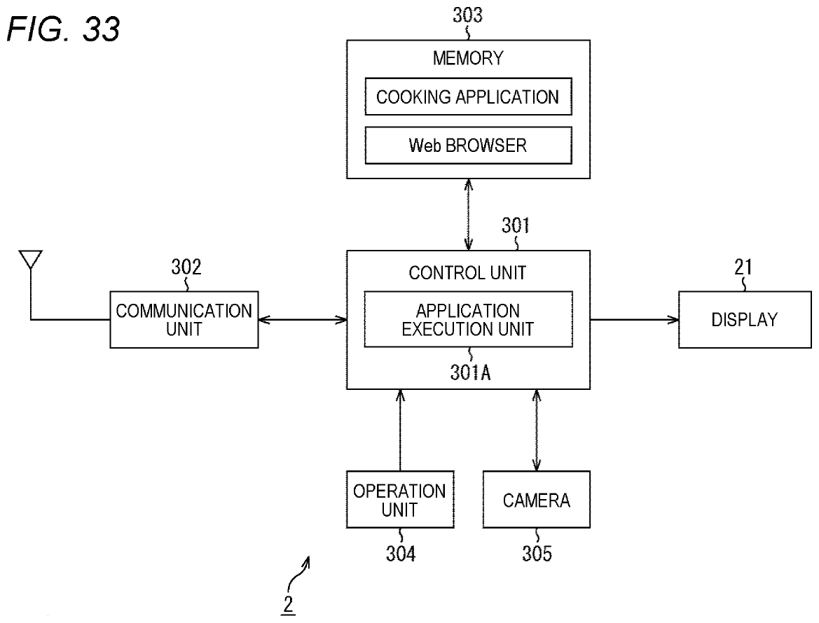

FIG. 33 is a block diagram illustrating an exemplary configuration of the mobile terminal 2.

As illustrated in FIG. 33, in addition to the display 21, a control unit 301, a communication unit 302, a memory 303, an operation unit 304, and a camera 305 are provided in the mobile terminal 2.

The control unit 301 includes a CPU, a ROM, a RAM, and the like. The control unit 301 controls the overall operation of the mobile terminal 2 due to execution of a predetermined program.

In the control unit 301, an application execution unit 301A is achieved. Various applications such as the cooking application are executed by the application execution unit 301A.

The communication unit 302 is a communication module for mobile communication such as long term evolution (LTE). The communication unit 302 communicates with the portable-kitchen management server 1 through the network 11. The communication unit 302 receives information transmitted from the portable-kitchen management server 1, and outputs the information to the control unit 301. Further, the communication unit 302 transmits, to the portable-kitchen management server 1, information supplied from the control unit 301.

The memory 303 includes a flash memory or the like. The memory 303 stores various types of information such as information transmitted from the portable-kitchen management server 1 and a program executed by the control unit 301. As illustrated in FIG. 33, the program executed by the control unit 301 includes the cooking application and the Web browser. A removable memory card may be used as a local storage for storing the cooking application and the Web browser.

The operation unit 304 includes various buttons and a touch panel overlapping the display 21. The operation unit 304 outputs a signal indicating the details of an operation by the user to the control unit 301.

The camera 305 captures an image (moving image, still image) in response to an operation by the user.

The display 21 includes an organic electroluminescent (EL) display, a liquid crystal display (LCD), and the like. Such various screens as described above are displayed on the display 21 on the basis of the information received by the communication unit 302.

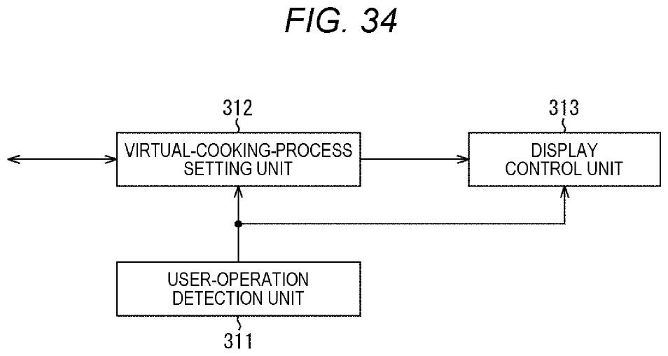

FIG. 34 is a block diagram illustrating an exemplary functional configuration of the mobile terminal 2.

As illustrated in FIG. 34, in the mobile terminal 2, a user-operation detection unit 311, a virtual-cooking-process setting unit 312, and a display control unit 313 are achieved. At least part of the functional units illustrated in FIG. 34 is achieved due to execution of the cooking application by the CPU 301 of FIG. 33. The mobile terminal 2 functions as a data processing apparatus that executes the cooking application to perform various pieces of processing.

The user-operation detection unit 311 detects an operation by the user on the screen displayed on the display 21 and outputs information indicating the details of the operation by the user. The information output from the user-operation detection unit 311 is supplied to the virtual-cooking-process setting unit 312 and the display control unit 313.

The virtual-cooking-process setting unit 312 controls the communication unit 302 to communicate with the portable-kitchen management server 1. On the basis of the information supplied from the user-operation detection unit 311, the virtual-cooking-process setting unit 312 transmits, to the portable-kitchen management server 1, information indicating the details of a user operation performed as virtual cooking by the user of the mobile terminal 2.

Further, on the basis of the information transmitted from the portable-kitchen management server 1, the virtual-cooking-process setting unit 312 synchronizes the state of the virtual cooking process of the virtual cooking by the user of the mobile terminal 2 with the state of the virtual cooking process of the virtual cooking by another user who is making a dish in cooperation. The virtual-cooking-process setting unit 312 sets and manages information indicating the state of the virtual cooking process for each user so as to be shared between the plurality of users.

The display control unit 313 controls the display of the screen of the cooking application in accordance with the state of the virtual cooking process for each user managed by the virtual-cooking-process setting unit 312 and in response to the operation by the user of the mobile terminal 2 detected by the user-operation detection unit 311.

The display control unit 313 performs such a display control of each screen such as the ingredient selection screen, the cooking screen, and the order screen as described above. Further, the display control unit 313 displays information indicating the workload of each user.

<Operation of Each Apparatus>

Here, the operation of each apparatus having such a configuration as described above will be described.

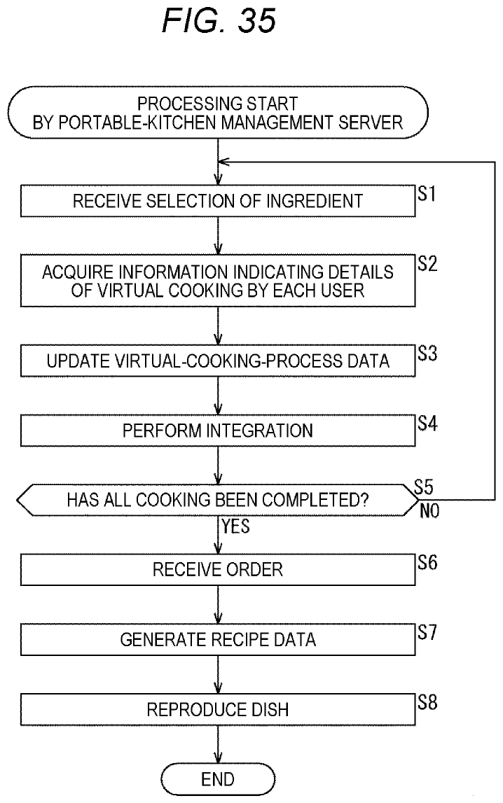

First, processing of the portable-kitchen management server 1 will be described with reference to the flowchart of FIG. 35.

The user of the mobile terminal 2 selects an ingredient by an operation on the ingredient selection screen displayed on the mobile terminal 2. The information regarding the ingredient selected by the user is transmitted to the portable-kitchen management server 1.

In step S1, on the basis of the information transmitted from the mobile terminal 2, the virtual-cooking-process-data update unit 231 of the portable-kitchen management server 1 receives the selection of the ingredient.

In step S2, the virtual-cooking-process-data update unit 231 acquires the information indicating the details of the virtual cooking by each user transmitted from the corresponding mobile terminal 2.

In step S3, the virtual-cooking-process-data update unit 231 updates the virtual-cooking-process data on the basis of the operation by each user relating to the virtual cooking.

In step S4, the integration unit 232 integrates the updated virtual-cooking-process data for each user. Synchronization of the virtual cooking processes between the plurality of users is ensured on the basis of the integrated virtual-cooking-process data obtained due to the integration by the integration unit 232.

In step S5, the virtual-cooking-process-data update unit 231 determines whether or not all the cooking has been completed.

In a case where it is determined in step S5 that all the cooking has not been completed, the flow returns to step S1 and the processing is repeated. The virtual dish is completed by repetition of virtual cooking while appropriately changing an ingredient.

In a case where it is determined in step S5 that all the cooking has been completed, the flow goes to step S6, and for example, the CPU 211 receives an order for reproducing the dish as a real dish.

In step S7, the recipe-data generation unit 233 generates recipe data on the basis of the integrated virtual-cooking-process data.

In step S8, on the basis of the recipe data, the command generation unit 234 generates an instruction command for controlling each cooking process, and sequentially outputs the instruction command to the cooking apparatus 3 to reproduce the dish. The cooking apparatus 3 performs cooking in each cooking process according to the instruction command supplied from the command generation unit 234, and the dish is reproduced finally.

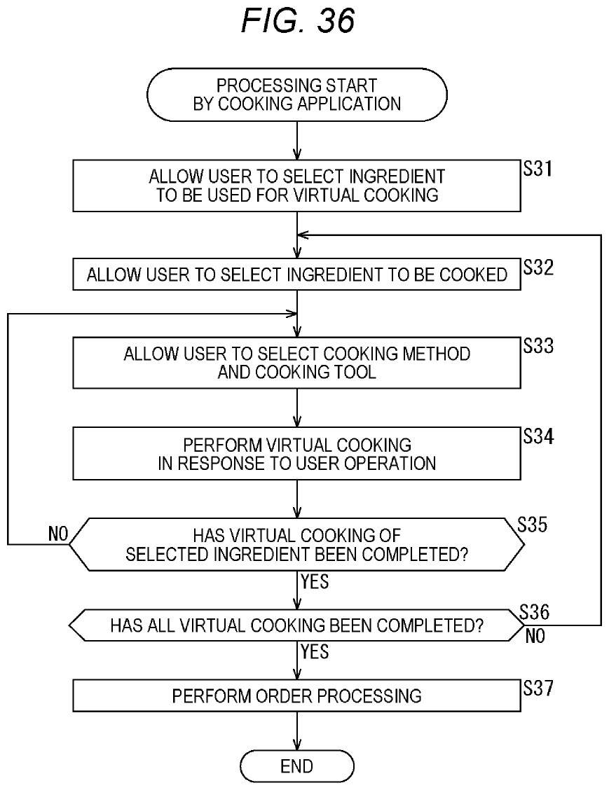

Next, processing of the cooking application of the mobile terminal 2 will be described with reference to the flowchart of FIG. 36.

In step S31, the display control unit 313 causes the display 21 to display the ingredient selection screen, and allows the user to select an ingredient to be used for virtual cooking.

Information indicating the details of the user operation detected by the user-operation detection unit 311 is transmitted from the virtual-cooking-process setting unit 312 to the portable-kitchen management server 1, and is managed using the virtual-cooking-process data. Furthermore, synchronization of the virtual cooking processes is secured between the plurality of users on the basis of the information transmitted from the portable-kitchen management server 1.

In step S32, the display control unit 313 allows the user to select an ingredient to be cooked.

In step S33, the display control unit 313 allows the user to select a cooking method and a cooking tool. For example, the cooking method and the cooking tool are selected using the cooking screen as described with reference to FIG. 11.

In step S34, in response to the user operation, the display control unit 313 performs virtual cooking with the selected cooking tool and others.

In step S35, the display control unit 313 determines whether or not the virtual cooking of the selected ingredient has been completed. In a case where it is determined in step S35 that the virtual cooking of the selected ingredient has not been completed, the flow returns to step S33, and the above processing is repeated.

In a case where it is determined in step S35 that the virtual cooking of the selected ingredient has been completed, in step S36, the display control unit 313 determines whether or not all the virtual cooking has been completed.

In a case where it is determined in step S36 that all the virtual cooking has not been completed, the flow returns to step S32, and the above processing is repeated.

In a case where it is determined in step S36 that all the virtual cooking has been completed, the flow goes to step S37, and the display control unit 313 displays an order screen on the display 21 and performs order processing. After transmission of order information indicating the details of the order from the mobile terminal 2 to the portable-kitchen management server 1, the processing ends.

The above processing enables the user to perform cooking in cooperation with another user by virtual cooking and to eat the dish made in such cooperation.

### SPECIFIC EXAMPLE OF VIRTUAL COOKING

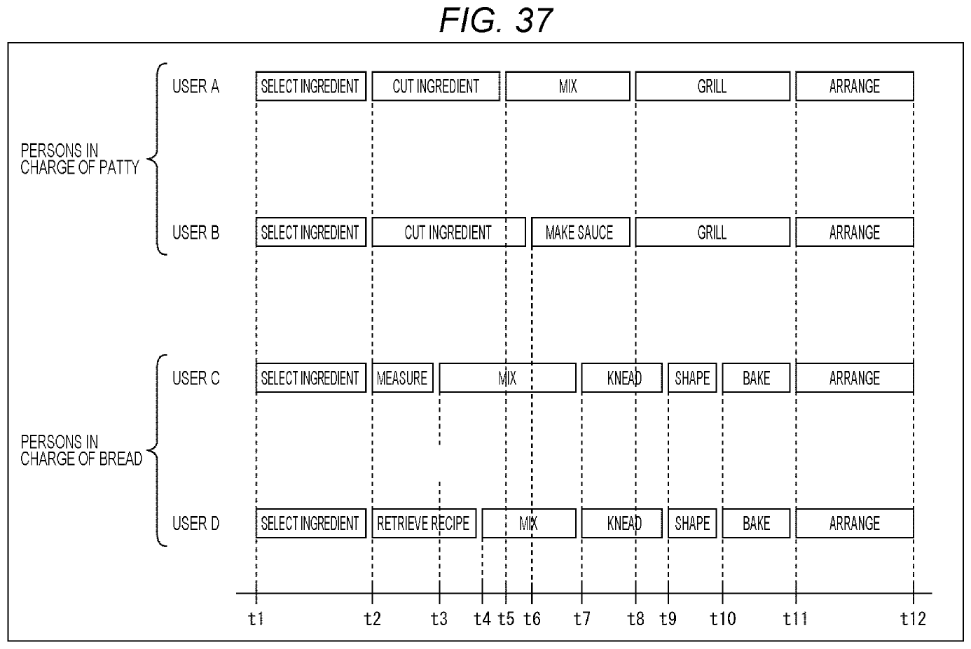

FIG. 37 is a timing chart of virtual cooking.

Here, a case where users A to D make hamburgers in cooperation to will be described. It is determined by, for example, discussion that the user A and the user B are in charge of the patty (hamburg steak) and the user C and the user D are in charge of the bread.

In the period between time t1 to time t2 in FIG. 37, the users A to D who operate the cooking application each select an ingredient. The user A and the user B each select an ingredient to be used for the patty, and the user C and the user D each select an ingredient to be used for the bread.

The user A in charge of the patty cuts the ingredient in the period between time t2 to time t5, and mixes the cut ingredients in the period between time t5 and time t8. The user B cuts the ingredient in the period between time t2 and time t6 and makes sauce in the period between time t6 and time t8. The user A and the user B perform cooking of pouring the sauce onto the patty and grilling the patty with the sauce poured thereon in the period between time t8 and time t11.

The user (user A or user B) who takes over a certain cooking process and is in charge of the next cooking process can view the history regarding the other's cooking process, so that the user can select and take over a process that is successful. In addition, in a case where cooking fails, for example, grilling too much of the patty, each user can redo the cooking.

Meanwhile, the user C in charge of the bread measures an ingredient such as flour in the period between time t2 to time t3, and mixes the measured ingredient in the period between time t3 and time t7. The user D retrieves a recipe in the period between time t2 and time t4, and mixes the ingredients in the form of being added to the cooking by the user C in the period between the time t4 to the time t7.

The recipe retrieved by a single user is shared with another user. Each user can view the recipe determined by the single user. A recipe for each dish is prepared in the cooking application. In addition, a plurality of users can simultaneously perform a single process of virtual cooking such that a certain user joins the virtual cooking by another user.

The user C and the user D shape the bread in the period between time t9 and time t10, and bake the bread in the period between time t11 and time t12. The shaping process can also proceed in cooperation such that the rest of the work by one user is taken over by the other user.

The users A to D each arrange the patty and the bread completed so far in the form of a hamburger in the period between time t11 and time t12. Four types of hamburgers different in arrangement are completed. For example, a single well-made hamburger is ordered for four persons.

### OTHER EXAMPLES

Exemplary Number of Persons

Although the case where a plurality of persons cooperates has been described, virtual cooking in all virtual cooking processes for completing a single dish may be performed by a single user.

Viewing of Highlighted Moving Image

A highlighted moving image obtained by collecting the states of virtual cooking may be generated by the portable-kitchen management server 1 such that the highlighted moving image can be viewed while eating the completed dish.

The portable-kitchen management server 1 collects moving images showing the state of the virtual cooking having a predetermined number of virtual cooking processes among all the virtual cooking processes for completion of a single dish and generates a highlighted moving image, for example. The highlighted moving image is generated on the basis of the integrated virtual-cooking-process data.

The cooking application of the mobile terminal 2 receives the highlighted moving image transmitted from the portable-kitchen management server 1, and reproduces and displays the highlighted moving image.

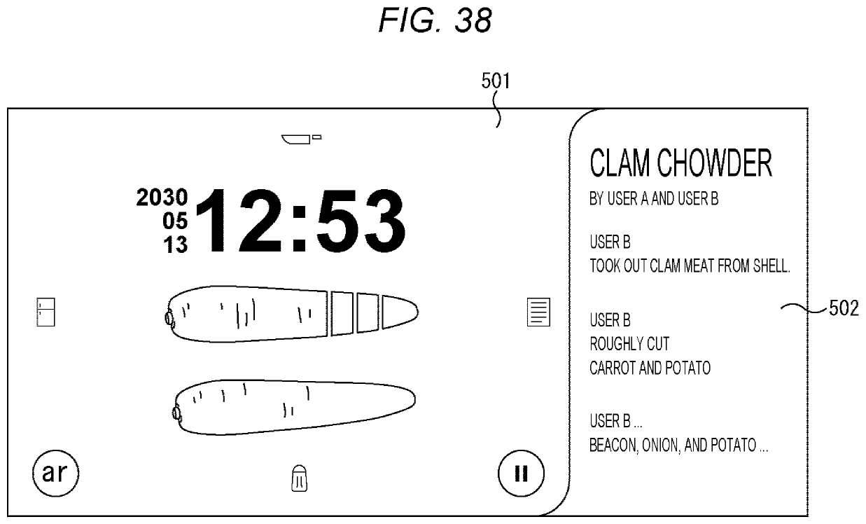

FIG. 38 is a diagram illustrating an exemplary display screen for the highlighted moving image.

The display screen for the highlighted moving image includes a moving image area 501 and a comment area 502 provided, respectively, on the left and right of the display screen. The highlighted moving image illustrated in FIG. 38 is a moving image showing a state of virtual cooking of making clam chowder.

The moving image area 501 is a display area for the highlighted moving image. In the example of FIG. 38, the moving image showing a state of virtual cooking of cutting carrot is displayed together with information such as the date and time when the virtual cooking is performed.

The comment area 502 is a display area for text data for explaining the details of the virtual cooking. In the example of FIG. 38, the details of the virtual cooking performed by the user A and the user B are shown in chronological order by the text data displayed in the comment area 502.

Viewing such a highlighted moving image enables a user to check his/her skill in virtual cooking later.

The highlighted moving image may be released to another user. In this case, the other user having viewed the highlighted moving image can set the evaluation for the virtual cooking or the completed dish by the user having released the highlighted moving image.

Virtual Cooking According to Attribute of User

The details of virtual cooking may be set in accordance with the attribute of a user. The attribute of the user includes nationality, gender, age, and the like.

For example, usable ingredients, seasonings, and cooking tools for the virtual cooking can be set in accordance with the attribute of the user. Ingredient information and cooking tool information included in a virtual-cooking-process data set are set in accordance with the attribute of the user.

In this case, usable ingredients, seasonings, and cooking tools are set in accordance with the age, for example, ingredients, seasonings, and cooking tools usable by an adult or ingredients, seasonings, and cooking tools usable by a child. Further, ingredients, seasonings, and cooking tools usable by a female or ingredients, seasonings, and cooking tools usable by a male are set in accordance with the gender.

A plurality of attributes may be combined and usable ingredients, seasonings, and cooking tools may be set. The dish that can be made may be set in accordance with the attribute of the user.

In a case where the skill level of virtual cooking is set for each user, the details of the virtual cooking may be set in accordance with the skill level as an attribute of the user.

The skill level is calculated, for example, by the portable-kitchen management server 1, on the basis of the time required for the virtual cooking, the speed, the taste estimated from the details of the virtual cooking, and others, and the skill level is set for each user. The skill level may be set by the user who has eaten the actual dish, or may be set in accordance with the evaluation by the other user for the highlighted moving image described above.

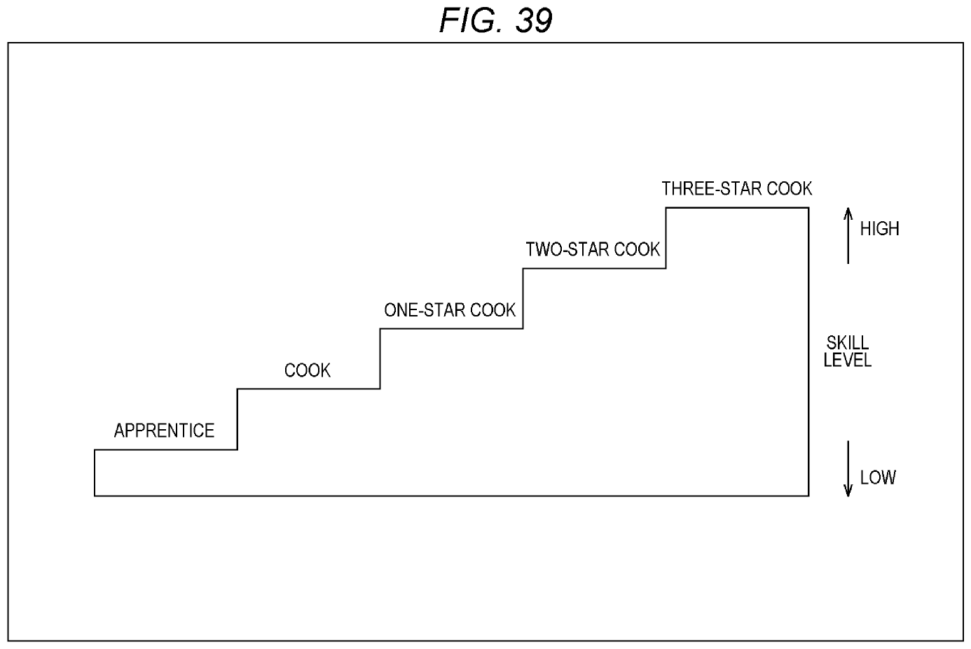

FIG. 39 is a diagram illustrating exemplary ranking according to the skill level.

In the example of FIG. 39, the ranks of “three-star cook”, “two-star cook”, “one-star cook”, “cook”, and “apprentice” are set in descending order of the skill levels. Ingredients, seasonings, and cooking tools usable for the virtual cooking are set, for example, in accordance with the rank.

For example, a restriction is set to a user ranked as the “apprentice” such that the user can use only inexpensive ingredients and seasonings in virtual cooking. On the other hand, for example, a user ranked as the “three-star cook” can use all ingredients and seasonings including expensive ones.

Further, a restriction is set to cooking tools such that the user ranked as “apprentice” can use only the cooking tools that are easy to operate in the virtual cooking. On the other hand, for example, the user ranked as “three-star cook” can use all cooking tools including those with a complicated operation.

Exemplary Program

The above flow of the processing can be executed by hardware or software. In a case where the above flow of the processing is executed by software, a program included in the software is installed onto, for example, a computer embedded in dedicated hardware or a general-purpose personal computer.

The program to be installed is provided by being recorded in a removable medium 221 illustrated in FIG. 31 including an optical disk (such as compact disc-read only memory (CD-ROM) or digital versatile disc (DVD)), a semiconductor memory, and the like. Alternatively, the program to be installed may be provided through a wired or wireless transmission medium such as a local area network, the Internet, or digital broadcasting. The program can be preinstalled in the ROM 212 or the storage unit 218.

Note that the program executed by the computer may be a program for chronologically performing the processing in accordance with the order described in the present description, may be a program for parallelly performing the processing or a program for performing the processing with necessary timing, for example, when a call is made.

In the present description, the system means a collection of a plurality of constituent elements (apparatuses, modules (components), and others). Thus, it is not concerned whether or not all the constituent elements are included in the same housing. Therefore, a plurality of apparatuses housed in separate housings and connected through a network, and a single apparatus having a plurality of modules housed in a single housing are both systems.

Note that the effects described in the present description are merely exemplified and are not intended to be limitative, and may have additional effects.

Embodiments of the present technology are not limited to the above embodiments, and various modifications can be made without departing from the gist of the present technology.

For example, the present technology can adopt a configuration of cloud computing in which a single function is subjected to processing by sharing and collaborating between a plurality of apparatuses through a network.

Further, each step described in the above flowcharts can be executed by a single apparatus, or can be executed by sharing between a plurality of apparatuses.

Furthermore, in a case where a plurality of pieces of processing is included in a single step, the plurality of pieces of processing included in the single step can be executed by a single apparatus, or can be executed by sharing between a plurality of apparatuses.

### REFERENCE SIGNS LIST

1 Portable-kitchen management server
2A, 2B Mobile terminal
3 Cooking apparatus
21 Display
201 Control apparatus
231 Virtual-cooking-process-data update unit
232 Integration unit
233 Recipe-data generation unit
234 Command generation unit
241 Generation unit
301 Control unit
311 User-operation detection unit
312 Virtual-cooking-process setting unit
313 Display control unit

1. A data processing apparatus comprising:
a generation unit configured to integrate virtual-cooking-process data indicating a process of virtual cooking in which a detail changes in response to a user operation on a cooking application for achievement of the virtual cooking as virtual cooking on an application, as integrated virtual-cooking-process data indicating the process of the virtual cooking by each of a plurality of users, for sharing between the plurality of users, the generation unit being configured to generate recipe data for a dish.

2. The data processing apparatus according to claim 1,
wherein in response to the user operation relating to the virtual cooking, the generation unit updates the virtual-cooking-process data for each of the plurality of users, and integrates the virtual-cooking-process data after the updating.

3. The data processing apparatus according to claim 2,
wherein the generation unit integrates the virtual-cooking-process data in which progress in the process of the virtual cooking changes in response to the user operation.

4. The data processing apparatus according to claim 3,
wherein the generation unit synchronizes the virtual-cooking-process data between the plurality of users.

5. The data processing apparatus according to claim 4, further comprising:
a communication unit configured to transmit, through a network, the virtual-cooking-process data synchronized by the generation unit to a terminal of each of the plurality of users that executes the cooking application.

6. The data processing apparatus according to claim 1,
wherein the generation unit generates, as the recipe data, data including a virtual-cooking-process data set in which cooking tool data indicating a cooking tool having been used in the process of the virtual cooking and ingredient data indicating an ingredient having been used in the process of the virtual cooking are linked together.

7. The data processing apparatus according to claim 6,
wherein the generation unit sets data included in the virtual-cooking-process data set, in accordance with an attribute of each of the plurality of users.

8. The data processing apparatus according to claim 7,
wherein the attribute of each of the plurality of users corresponds to a skill level for the process of the virtual cooking in the cooking application, and
the generation unit sets the cooking tool data and the ingredient data, in accordance with the skill level.

9. The data processing apparatus according to claim 6,
wherein with a history regarding the virtual cooking having been performed, as the virtual cooking having the process constant, a plurality of times by each of the plurality of users, the generation unit generates the integrated virtual-cooking-process data.

10. The data processing apparatus according to claim 1, further comprising:
a command generation unit configured to generate, on a basis of the recipe data generated by the generation unit, an instruction command for controlling a cooking operation of a cooking robot that performs cooking in real space.

11. The data processing apparatus according to claim 1, further comprising:
a conversion unit configured to convert the recipe data generated by the generation unit into data readable by a cook who performs cooking in real space.

12. A data processing method to be performed by a data processing apparatus, the data processing method comprising:
integrating virtual-cooking-process data indicating a process of virtual cooking in which a detail changes in response to a user operation on a cooking application for achievement of the virtual cooking as virtual cooking on an application, as integrated virtual-cooking-process data indicating the process of the virtual cooking by each of a plurality of users, for sharing between the plurality of users, and generating recipe data for a dish.

13. A data processing apparatus comprising:
a setting unit configured to set virtual-cooking-process data indicating a process of virtual cooking in which a detail changes in response to a user operation on a cooking application for achievement of the virtual cooking as virtual cooking on an application, such that the virtual-cooking-process data is shared between a plurality of users.

14. The data processing apparatus according to claim 13,
wherein in response to the user operation relating to the virtual cooking, the virtual-cooking-process data is updated for each of the plurality of users.

15. The data processing apparatus according to claim 14,
wherein in response to the user operation, the virtual-cooking-process data is synchronized between the plurality of users.

16. The data processing apparatus according to claim 13,
wherein the recipe data corresponds to data including a virtual-cooking-process data set in which cooking tool data indicating a cooking tool having been used in the process of the virtual cooking and ingredient data indicating an ingredient having been used in the process of the virtual cooking are linked together.

17. The data processing apparatus according to claim 16,
wherein data included in the virtual-cooking-process data set is set in accordance with an attribute of each of the plurality of users.

18. The data processing apparatus according to claim 17,
wherein the attribute of each of the plurality of users corresponds to a skill level for the process of the virtual cooking in the cooking application, and
the cooking tool data and the ingredient data are set in accordance with the skill level.

19. The data processing apparatus according to claim 13, further comprising:
a display control unit configured to display, on a screen, information indicating workload of the virtual cooking by each of the plurality of users who uses the cooking application, in conjunction with the user operation by the corresponding user.

20. A data processing method to be performed by a data processing apparatus, the data processing method comprising:
setting virtual-cooking-process data indicating a process of virtual cooking in which a detail changes in response to a user operation on a cooking application for achievement of the virtual cooking as virtual cooking on an application, such that the virtual-cooking-process data is shared between a plurality of users.
